(19) United States
(12) Patent Application Publication
(10) Pub. No.: US 2026/0321983 A1
(43) Pub. Date: Oct. 15, 2026

(54) Resonant Cavity Antenna and Electronic Device

(71) Applicant: HUAWEI TECHNOLOGIES CO., LTD., Shenzhen (CN)

(72) Inventors: Guangyao Zhu, Wuhan (CN); Xiaogang Hu, Wuhan (CN); Zhaoxuan Liu, Wuhan (CN); Quan Xiang, Wuhan (CN); Zhiwei Jiang, Wuhan (CN)

(73) Assignee: HUAWEI TECHNOLOGIES CO., LTD., Shenzhen (CN)

(21) Appl. No.: 19/696,942

(22) Filed: Jun. 3, 2026

Related U.S. Application Data
(63) Continuation of application No. PCT/CN2025/087608, filed on Apr. 7, 2025.

(30) Foreign Application Priority Data
Apr. 22, 2024 (CN) 202410483819.1

(51) Int. Cl. H01Q 13/18; H01Q 1/38

(52) U.S. Cl. CPC H01Q 13/18; H01Q 1/38

(57) ABSTRACT

A resonant cavity antenna comprises a closed internal cavity, and the internal cavity is configured to communicate with an audio chamber of an audio module to serve as a portion of an acoustic cavity of the audio module. The resonant cavity antenna further comprises a dielectric substrate, and a metal sheet and a metal ground that are fastened to the dielectric substrate. The metal sheet and the metal ground are spaced apart, a ground point of the metal sheet is conductively connected to the metal ground, and the metal sheet and the metal ground form a resonant cavity body.

### CROSS-REFERENCE TO RELATED APPLICATIONS

This is a continuation of International Patent Application No. PCT/CN2025/087608 filed on Apr. 7, 2025, which claims priority to Chinese Patent Application No. 202410483819.1 filed on Apr. 22, 2024, all of which are hereby incorporated by reference in their entireties.

### TECHNICAL FIELD

This application relates to the field of terminal device technologies, and in particular, to a resonant cavity antenna and an electronic device.

### BACKGROUND

Currently, consumers have high requirements for terminal devices in terms of appearance, texture, and lightweight experience. Structures of the terminal devices are evolving from a sandwich architecture to an all-metal unibody design. All-metal bodies of the terminal devices are generally designed without seams, and resonant cavity antennas may be used to meet communication requirements of the terminal devices.

However, a resonant cavity antenna in some technologies usually has a large physical structure, and occupies large space in a terminal device. This reduces space of an acoustic cavity of a speaker module, affecting sound quality of a speaker.

### SUMMARY

Embodiments of this application provide a resonant cavity antenna and an electronic device. The resonant cavity antenna uses its own structure to expand a volume of an acoustic cavity of an audio module, so that sound quality of the audio module can be optimized.

According to a first aspect, this application provides a resonant cavity antenna. The resonant cavity antenna may be used to play a communication function in an electronic device, and the electronic device further includes an audio module configured to make a sound. The resonant cavity antenna has a closed internal cavity, and the internal cavity is configured to communicate with an audio chamber of the audio module to serve as a portion of an acoustic cavity of the audio module. The resonant cavity antenna includes a dielectric substrate, and a metal sheet and a metal ground that are fastened to the dielectric substrate. The metal sheet and the metal ground are spaced apart, a ground point of the metal sheet is conductively connected to the metal ground, and the metal sheet and the metal ground form a resonant cavity body. An electromagnetic wave sent or received by the resonant cavity antenna may be reflected in the resonant cavity body. The internal cavity is at least partially located between the metal sheet and the metal ground.

The foregoing resonant cavity antenna forms the internal cavity based on its own structure, without increasing space occupied by the resonant cavity antenna. The internal cavity communicates with the audio chamber of the audio module, so that volume expansion of the acoustic cavity of the audio module can be implemented. This may improve sound quality of the audio module, alleviating space compression effect of the large-sized resonant cavity antenna on the audio module.

According to different antenna implementations, the metal sheet may be a steel sheet or a flexible printed circuit board (FPCB).

To space the metal sheet apart from the metal ground, the dielectric substrate has a first surface and a second surface that are opposite to each other. The metal sheet is fastened to the first surface of the dielectric substrate, and the ground point of the metal sheet is exposed from the second surface of the dielectric substrate. The metal ground is fastened to the second surface of the dielectric substrate and is conductively connected to the ground point of the metal sheet.

The internal cavity formed by the resonant cavity antenna may be implemented in a plurality of manners.

In some possible implementations, the dielectric substrate includes a hollow through which the first surface communicates with the second surface, and the metal sheet seals an opening that is of the hollow and that is located on the first surface. The metal ground may seal an opening that is of the hollow and that is located on the second surface. In this case, the metal sheet, the hollow of the dielectric substrate, and the metal ground form the internal cavity. A mechanical part may be made of a plastic material, and the mechanical part may be further disposed between the second surface of the dielectric substrate and the metal ground. To implement a conductive connection between the ground point of the metal sheet and the metal ground, the mechanical part needs to avoid interfering with the ground point of the metal ground, so that the ground point of the metal sheet is exposed from the second surface and is conductively connected to the metal ground. The metal sheet and the dielectric substrate may be formed by using an integrated injection molding process. The metal ground and the mechanical part may be formed by using an integrated injection molding process, and then the mechanical part is connected to the dielectric substrate.

Alternatively, the dielectric substrate includes a hollow through which the first surface communicates with the second surface, and the metal sheet seals an opening that is of the hollow and that is located on the first surface. The resonant cavity antenna includes a mechanical part, the mechanical part is configured to seal an opening that is of the hollow and that is located on the second surface, and the metal sheet, the hollow of the dielectric substrate, and the mechanical part form the internal cavity. Alternatively, the mechanical part may be made of a metal material. The mechanical part made of the metal material may be thin in thickness. Based on an unchanged overall thickness of the resonant cavity antenna, the thinner mechanical part can expand the internal cavity, and further expand a volume of the acoustic cavity when the internal cavity is connected to the audio chamber of the audio module. When the mechanical part is made of a metal material such as a steel sheet, the ground point of the metal sheet may be connected to the mechanical part, and the mechanical part is connected to the metal ground. It is equivalent to the ground point of the metal sheet being connected to the metal ground through the mechanical part.

In some possible implementations, the dielectric substrate includes an open slot with an opening located on the first surface, the metal sheet seals the opening that is of the open slot and that is located on the first surface, and the metal sheet and the open slot of the dielectric substrate form the internal cavity. The metal sheet and the dielectric substrate may form the internal cavity by using an integrated injection molding process.

In some possible implementations, the dielectric substrate includes an open slot with an opening located on the second surface, the metal ground seals an opening that is of the open slot and that is located on the first surface, and the metal ground and the open slot of the dielectric substrate form the internal cavity. The metal sheet and the dielectric substrate may be formed by using an integrated injection molding process, and then the metal ground is fastened to the second surface of the dielectric substrate to seal the opening of the open slot.

Alternatively, the dielectric substrate includes an open slot with an opening located on the second surface. The resonant cavity antenna includes a mechanical part, the mechanical part seals an opening that is of the open slot and that is located on the first surface, and the mechanical part and the open slot of the dielectric substrate form the internal cavity. The metal sheet and the dielectric substrate may be formed by using an integrated injection molding process. The metal ground and the mechanical part may be formed by using an integrated injection molding process, and then the mechanical part is connected to the dielectric substrate.

In some possible implementations, the dielectric substrate is of a cavity structure, and an inner wall of the cavity structure forms the internal cavity.

In some possible implementations, the dielectric substrate includes a first substrate and a second substrate that are connected to each other. A surface that is of the first substrate and that is away from the second substrate is the first surface, and the metal sheet may be fastened to the first substrate by using an integrated injection molding process. A surface that is of the second substrate and that is away from the first substrate is the second surface, and the metal ground may be fastened to the second substrate by using an integrated injection molding process. It should be understood that, according to different implementations in which the dielectric substrate has the cavity structure, has the hollow that runs through the first surface and the second surface, and has the open slot with the opening located on the first surface or the second surface, specific structures of the first substrate and the second substrate need to be adaptively adjusted accordingly.

In some possible implementations, the dielectric substrate includes a first connection port and a communication channel, the communication channel is connected between the internal cavity and the first connection port, and the first connection port is configured to communicate with the audio chamber of the audio module.

In some possible implementations, the metal sheet includes a top plate and a pin connected to the top plate, and the pin is configured to connect to the metal ground as the ground point of the metal sheet. One end that is of the pin and that is connected to a metal housing may be in surface contact with the metal housing, thereby improving contact reliability.

In some possible implementations, the ground point of the metal sheet is connected to the metal ground through conductive foam. The conductive foam serves an electrical connection function and can play a buffer role. In addition, a deformable property of the conductive foam allows for a tighter and more continuous connection between the metal housing and the metal sheet.

According to a second aspect, this application provides an electronic device. The electronic device may be a device that has a communication function and an audio function, for example, a mobile phone or a tablet computer. The resonant cavity antenna includes a dielectric substrate, and a metal sheet and a metal ground that are fastened to the dielectric substrate. The metal sheet and the metal ground are spaced apart, a ground point of the metal sheet is conductively connected to the metal ground, and the metal sheet and the metal ground form a resonant cavity body. The resonant cavity antenna includes a closed internal cavity, and at least a portion of the internal cavity is a portion of the resonant cavity body. The audio module has an audio chamber, and the audio chamber communicates with the internal cavity. The internal cavity may be used as a portion of an acoustic cavity of the audio module, to expand a volume of the audio module.

In some possible implementations, the electronic device includes a metal housing, and a portion of the metal housing is the metal ground of the resonant cavity antenna.

In some possible implementations, the metal housing includes a metal casing and a metal middle frame perpendicular to the metal casing, and the dielectric substrate is fastened to the metal casing. A surface that is of the dielectric substrate and that is configured to be fastened to the metal ground includes a first side edge and a second side edge that are opposite to each other, the first side edge is adjacent to the metal middle frame, and the second side edge is opposite to the metal middle frame. The ground point that is of the metal sheet and that is configured to connect to the metal ground is disposed on the second side edge.

In some possible implementations, a gap exists between the resonant cavity antenna and the metal middle frame, and the resonant cavity antenna is configured to transmit or receive an electromagnetic wave through the gap.

In a possible implementation, the resonant cavity antenna includes a first connection port, and the first connection port communicates with the internal cavity. The audio module includes a second connection port, the second connection port communicates with the audio chamber, and the second connection port is in sealed communication with the first connection port. A sealing ring may be disposed between the first connection port and the second connection port, and the sealing ring surrounds a channel formed by communication between the first connection port and the second connection port. The sealing ring may be sealing foam or a sealing rubber sleeve.

In a possible implementation, the audio module and the resonant cavity antenna are disposed at a same layer, and an end face that is of the first connection port and that is used for connection to the second connection port is inclined and parallel to an end face that is of the second connection port and that is used for connection to the first connection port in an arrangement direction of the audio module and the resonant cavity antenna. When the audio module fits with the resonant cavity antenna, the first connection port and the second connection port are arranged in a thickness direction of the electronic device, so that the first connection port and the second connection port can be crimped and sealed, thereby improving connection tightness.

In a possible implementation, the resonant cavity antenna includes a first boss, the audio module includes a second boss, and the first boss laps over and is fastened to the second boss in a direction perpendicular to the arrangement direction of the audio module and the resonant cavity antenna. A connector such as a bolt or a screw may sequentially pass through the first boss and the second boss to be fastened to the metal housing of the electronic device.

According to a third aspect, an electronic device is provided. The electronic device may be a device that has a communication function and an audio function, for example, a mobile phone or a tablet computer. In this application, the electronic device includes an audio module and any resonant cavity antenna provided in the first aspect. An internal cavity of the resonant cavity antenna can communicate with the audio module of the audio module to expand a volume of an acoustic cavity. For a structure of the resonant cavity antenna, refer to the resonant cavity antenna provided in the first aspect.

### BRIEF DESCRIPTION OF DRAWINGS

FIG. 1A is a diagram of a structure of an electronic device according to an embodiment of this application;

FIG. 1B is a diagram of a partial structure of an electronic device according to an embodiment of this application;

FIG. 1C is an enlarged view of details at V1 in FIG. 1B;

FIG. 2 is a simplified diagram of a structure of a design in which a resonant cavity antenna and an audio module of an electronic device share a cavity according to an embodiment of this application;

FIG. 3 is a simplified diagram of a partial cross-sectional structure of a resonant cavity antenna according to an embodiment of this application;

FIG. 4A is a diagram of a structure of a resonant cavity antenna according to Embodiment 1 of this application;

FIG. 4B is a diagram of a structure of a resonant cavity antenna according to Embodiment 1 of this application;

FIG. 4C is an exploded view of a resonant cavity antenna according to Embodiment 1 of this application;

FIG. 4D is an exploded view of a resonant cavity antenna according to Embodiment 1 of this application;

FIG. 5 is a diagram of a partial cross-sectional structure of a resonant cavity antenna according to Embodiment 1 of this application;

FIG. 6A is a diagram of a structure of a design in which a resonant cavity antenna and an audio module of an electronic device share a cavity according to Embodiment 1 of this application;

FIG. 6B is an enlarged view of details at V2 in FIG. 6A;

FIG. 6C is an enlarged view of details at V3 in FIG. 6A;

FIG. 6D is a diagram of a structure of a design in which a resonant cavity antenna and an audio module of an electronic device share a cavity according to Embodiment 1 of this application;

FIG. 7A is a diagram of a structure of a resonant cavity antenna and an audio module of an electronic device according to Embodiment 1 of this application;

FIG. 7B is a diagram of a structure of a resonant cavity antenna and an audio module of an electronic device according to Embodiment 1 of this application;

FIG. 7C is a diagram of a partial cross-sectional structure of a design in which a resonant cavity antenna and an audio module of an electronic device share a cavity according to Embodiment 1 of this application;

FIG. 8A is a diagram of a partial structure of an electronic device according to Embodiment 1 of this application;

FIG. 8B is a diagram of a partial cross-sectional structure of an electronic device according to Embodiment 1 of this application;

FIG. 9 is a simplified diagram of a partial cross-sectional structure of a resonant cavity antenna according to Embodiment 2 of this application;

FIG. 10A is a diagram of a structure of a resonant cavity antenna according to Embodiment 2 of this application;

FIG. 10B is an exploded view of a resonant cavity antenna according to Embodiment 2 of this application;

FIG. 10C is an exploded view of a resonant cavity antenna according to Embodiment 2 of this application;

FIG. 11 is a diagram of a partial cross-sectional structure of a resonant cavity antenna according to Embodiment 2 of this application;

FIG. 12 is a simplified diagram of a partial cross-sectional structure of a resonant cavity antenna according to Embodiment 3 of this application;

FIG. 13A is a diagram of a structure of a resonant cavity antenna according to Embodiment 3 of this application;

FIG. 13B is a diagram of a structure of a resonant cavity antenna according to Embodiment 3 of this application;

FIG. 13C is an exploded view of a resonant cavity antenna according to Embodiment 3 of this application;

FIG. 13D is an exploded view of a resonant cavity antenna according to Embodiment 3 of this application;

FIG. 14 is a diagram of a partial cross-sectional structure of a resonant cavity antenna according to Embodiment 3 of this application;

FIG. 15 is a simplified diagram of a partial cross-sectional structure of a resonant cavity antenna according to Embodiment 4 of this application;

FIG. 16 is an exploded view of a resonant cavity antenna according to Embodiment 4 of this application;

FIG. 17 is a diagram of a partial cross-sectional structure of a resonant cavity antenna according to Embodiment 4 of this application;

FIG. 18 is a simplified diagram of a partial cross-sectional structure of a resonant cavity antenna according to Embodiment 5 of this application;

FIG. 19 is an exploded view of a resonant cavity antenna according to Embodiment 5 of this application;

FIG. 20 is a diagram of a partial cross-sectional structure of a resonant cavity antenna according to Embodiment 5 of this application;

FIG. 21 is a simplified diagram of a partial cross-sectional structure of a resonant cavity antenna according to Embodiment 6 of this application;

FIG. 22A is an exploded view of a resonant cavity antenna according to Embodiment 6 of this application;

FIG. 22B is an exploded view of a resonant cavity antenna according to Embodiment 6 of this application;

FIG. 23 is a diagram of a partial cross-sectional structure of a resonant cavity antenna according to Embodiment 6 of this application;

FIG. 24 is a simplified diagram of a partial cross-sectional structure of a resonant cavity antenna according to Embodiment 7 of this application;

FIG. 25A is an exploded view of a resonant cavity antenna according to Embodiment 7 of this application;

FIG. 25B is an exploded view of a resonant cavity antenna according to Embodiment 7 of this application;

FIG. 26 is a diagram of a partial cross-sectional structure of a resonant cavity antenna according to Embodiment 7 of this application;

FIG. 27 is a simplified diagram of a partial cross-sectional structure of a resonant cavity antenna according to Embodiment 8 of this application;

FIG. 28 is a diagram of a partial cross-sectional structure of a resonant cavity antenna according to Embodiment 8 of this application;

FIG. 29 is a simplified diagram of a partial cross-sectional structure of a resonant cavity antenna according to Embodiment 9 of this application;

FIG. 30A is an exploded view of a resonant cavity antenna according to Embodiment 9 of this application;

FIG. 30B is an exploded view of a resonant cavity antenna according to Embodiment 9 of this application; and

FIG. 31 is a diagram of a partial cross-sectional structure of a resonant cavity antenna according to Embodiment 9 of this application.

Reference numerals: 10: resonant cavity antenna; 101: first connection port; 102: communication channel; 20: metal housing; 201: metal casing; 202: metal middle frame; 30: audio module; 301: second connection port; 40: screen; 50: sealing ring; 60: conductive foam; 70: buffer foam; 80: sealing foam; 1: metal sheet; 11: pin; 12: top plate; 2: dielectric substrate; 21: first substrate; 22: second substrate; 23: protrusion; 3: metal ground; 4: mechanical part; 5: connector; a1: first surface; a2: second surface; c: sound outlet hole; d1: first side edge; d2: second side edge; j: gap; s1: injection molding hole; s2: protrusion; t: annular boss; B: avoidance opening; C: open slot; J: connection hole; K1: first through hole; K2: second through hole; Q1: internal cavity; Q2: audio chamber; T1: first boss; T2: second boss; U1: first through groove; U2: second through groove; V: hollow.

### DESCRIPTION OF EMBODIMENTS

With the development of science and technology, terminal devices are advancing with each passing day. Consumers have basic requirements for the terminal devices in terms of communication, photography, and audio, and seek better appearance, texture, and lightweight experience of the terminal devices. Existing terminal devices are gradually evolving from a sandwich architecture to an all-metal unibody design. To ensure seamless appearance design of a metal body, an antenna solution is usually designed as a resonant cavity antenna. A main problem with the resonant cavity antenna is that the resonant cavity antenna is usually of a large physical structure. This reduces cavity space of an acoustic cavity of a speaker module, affecting sound quality of a speaker.

In view of this current situation, this application provides a resonant cavity antenna and an electronic device having the resonant cavity antenna. An internal cavity of the resonant cavity antenna can be configured to communicate with an audio chamber of the electronic device, so that the internal cavity serves as a portion of an acoustic cavity of an audio module, to expand a volume of the acoustic cavity of the audio module. This optimizes sound quality while satisfying antenna performance.

To make the objectives, technical solutions, and advantages of this application clearer, the following further describes this application in detail with reference to the accompanying drawings.

Terms used in the following embodiments are merely intended to describe specific embodiments, but are not intended to limit this application. The terms “one”, “a”, “the”, “the foregoing”, and “this” of singular forms used in this specification and the appended claims of this application are also intended to include expressions such as “one or more”, unless otherwise specified in the context clearly.

Reference to “an embodiment”, “some embodiments”, or the like described in this specification indicates that one or more embodiments of this application include a specific feature, structure, or characteristic described with reference to the embodiment. Therefore, statements “in an embodiment”, “in some embodiments”, “in some other embodiments”, “in still some other embodiments”, and the like in different parts of this specification unnecessarily reference a same embodiment, but mean “one or more embodiments but not all embodiments”, unless otherwise specified particularly. Terms “include”, “comprise”, “have”, and variants thereof all mean “include but are not limited to”, unless otherwise specified particularly.

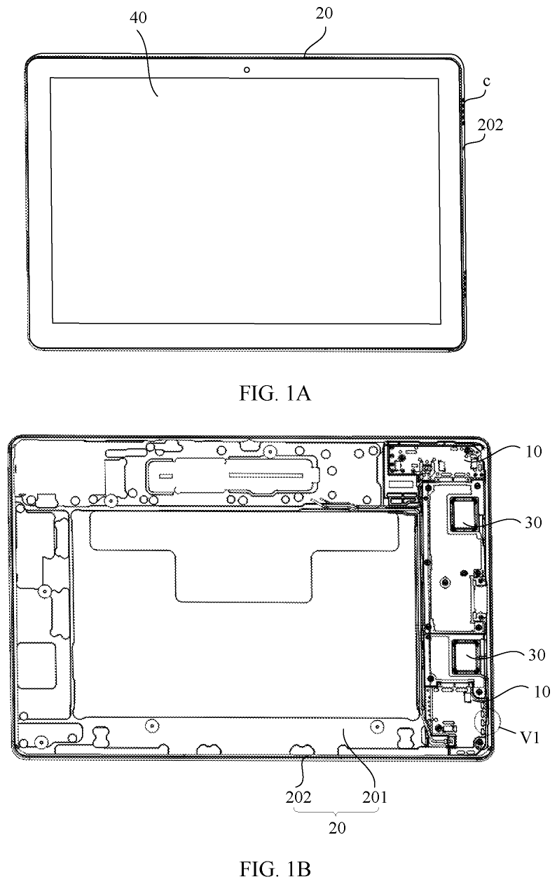

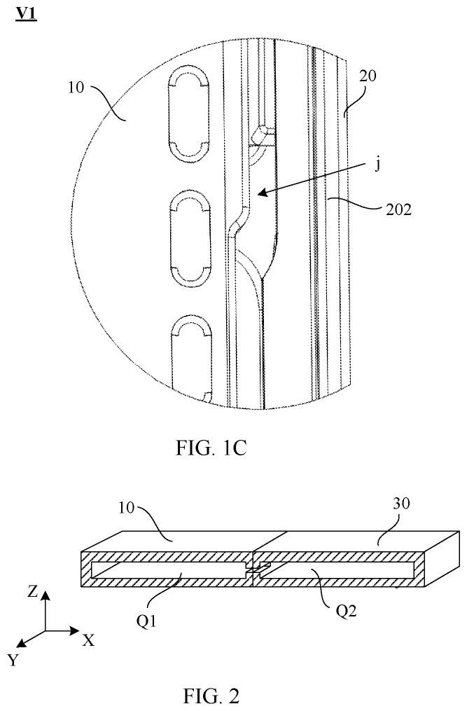

An embodiment of this application provides an electronic device. As a terminal device, the electronic device may be further a notebook computer, a tablet computer, a mobile phone, a wearable device, or the like. The electronic device has an integrated metal housing, and has audio and communication functions. For example, the electronic device is a tablet computer shown in FIG. 1A. The tablet computer includes a metal housing 20 and a screen 40. The screen 40 is embedded in the metal housing 20. Space used for accommodating another component of the tablet computer is formed between the screen 40 and the metal housing 20. With reference to a partial structure of the tablet computer without the screen 40 shown in FIG. 1B, the tablet computer further includes an audio module 30 and a resonant cavity antenna 10. The audio module 30 and the resonant cavity antenna 10 are disposed between the metal housing 20 and the screen 40. The metal housing 20 of the electronic device provided in this embodiment of this application is designed as an integrated structure without a seam, and therefore, the resonant cavity antenna 10 is used for communication.

Refer to FIG. 1A and FIG. 1B together. The metal housing 20 includes a metal casing 201 and a metal middle frame 202. The metal casing 201 may be considered as a bottom wall of the metal housing 20, the metal middle frame 202 may be considered as a side wall of the metal housing 20, and the metal middle frame 202 is disposed around an edge of the metal casing 201. For example, a sound outlet hole c is disposed at a position of the metal middle frame 202. The audio module 30 may be disposed corresponding to the sound outlet hole c, and sound emitted by the audio module 30 may be transmitted out through the sound outlet hole c. Further, there may be one or more audio modules 30. Different audio modules 30 are distributed at different positions at corners of the metal housing 20 according to a design of the electronic device. FIG. 1C is an enlarged view of details at V1 in FIG. 1B. As shown in FIG. 1C, a gap j exists between a side edge of the resonant cavity antenna 10 and the metal middle frame 202 of the metal housing 20, and the screen 40 covers the gap j when the screen 40 is installed on the metal housing 20. The screen 40 does not affect transmission of an electromagnetic wave. When the resonant cavity antenna 10 is installed inside the metal housing 20 of the electronic device, the resonant cavity antenna 10 may transmit or receive the electromagnetic wave through the gap j.

Based on the electronic device shown in FIG. 1A and FIG. 1B, an example of the audio module 30 in FIG. 1B is two treble speakers. Larger space of an audio chamber indicates better sound quality. In the electronic device provided in this embodiment of this application, the audio module 30 may share a cavity with the adjacent resonant cavity antenna 10, to expand a volume of an acoustic cavity.

FIG. 2 is a simplified diagram of a cross-sectional structure of a design in which a resonant cavity antenna 10 and an audio module 30 share a cavity. As shown in FIG. 2, the resonant cavity antenna 10 has an internal cavity Q1. The internal cavity Q1 is relatively closed space formed by a structure of the resonant cavity antenna 10. The audio module 30 has an audio chamber Q2. The resonant cavity antenna 10 is connected to the audio module 30, so that the internal cavity Q1 communicates with the audio chamber Q2. The internal cavity Q1 is in sealed communication with the audio chamber Q2 to form an acoustic cavity of the audio module 30. In other words, the closed acoustic cavity may be formed between the resonant cavity antenna 10 and the audio module 30. It should be understood that, the relatively closed space formed by the internal cavity Q1 herein is space that has no other openings except for an opening being communicated with the audio chamber Q2. This satisfies a design requirement of the audio module 30 for the closed acoustic cavity. For ease of understanding, a three-dimensional reference coordinate system is established in FIG. 2, where an X direction, a Y direction, and a Z direction are perpendicular to each other. With reference to the electronic device shown in FIG. 1A and FIG. 1B, the X direction is an arrangement direction of the resonant cavity antenna 10 and the audio module 30, and the X direction is parallel to the metal casing 201 of the electronic device. The Y direction is parallel to the metal casing 201 and is perpendicular to the X direction. The Z direction is perpendicular to the metal casing 201. It may be considered that the Z direction is a thickness direction of the resonant cavity antenna 10.

For the resonant cavity antenna 10, a resonant cavity that is of the resonant cavity antenna 10 and that is used for reflecting an electromagnetic wave basically adapts to a size of the resonant cavity antenna 10. The internal cavity Q1 is a portion of the resonant cavity of the resonant cavity antenna 10, or at least shares a portion of space with the resonant cavity of the resonant cavity antenna 10. In other words, based on a structure of the resonant cavity antenna 10, a structure design of the internal cavity Q1 does not increase space occupied by the resonant cavity antenna 10. The resonant cavity antenna 10 forms the internal cavity Q1 that communicates with the audio chamber Q2 of the audio module 30, so that volume expansion of the acoustic cavity of the audio module 30 can be implemented. This may improve sound quality of the audio module 30, alleviating space compression effect of the large-sized resonant cavity antenna 10 on the audio module 30. It should be understood that the electronic device may further include some bass speakers that do not require large space for the acoustic cavity, which are not exemplified herein.

The resonant cavity antenna 10 provided in this embodiment of this application may be implemented in a plurality of manners. The following describes a design in which the resonant cavity antenna 10 and the audio module 30 share a cavity by using examples through a plurality of specific embodiments.

### Embodiment 1

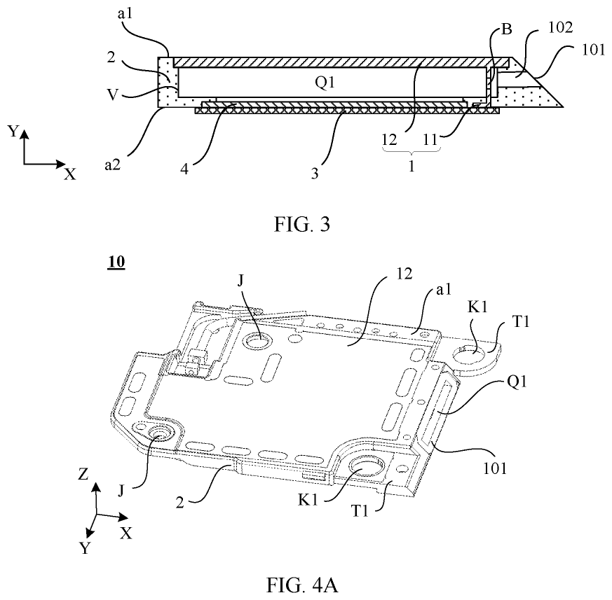

FIG. 3 is a simplified diagram of a cross-sectional structure of a resonant cavity antenna 10. The resonant cavity antenna 10 includes a metal sheet 1, a dielectric substrate 2, a metal ground 3, and a mechanical part 4. The metal sheet 1, the dielectric substrate 2, and the mechanical part 4 can work with each other to form the internal cavity Q1. In a Z direction, the dielectric substrate 2 includes a first surface a1 and a second surface a2 that are opposite to each other. In the Z direction, the metal sheet 1 includes a top plate 12 and at least one pin 11. At least a portion of the top plate 12 is located on the first surface a1 of the dielectric substrate 2. The pin 11 is connected to the top plate 12 and extends to the second surface a2 of the dielectric substrate 2. The pin 11 is connected to the metal ground 3. The dielectric substrate 2 has a hollow V that runs through the first surface a1 and the second surface a2. The top plate 12 of the metal sheet 1 can cover an opening on the first surface a1 of the dielectric substrate 2, and the mechanical part 4 can cover an opening on the second surface a2 of the dielectric substrate 2, so that the metal sheet 1, the dielectric substrate 2, and the mechanical part 4 form the closed internal cavity Q1.

The resonant cavity antenna 10 further includes a first connection port 101 communicated with the internal cavity Q1, and the first connection port 101 is configured to communicate with an audio chamber of the audio module 30. For example, the first connection port 101 communicates with the internal cavity Q1 through a communication channel 102, and both the first connection port 101 and the communication channel 102 are formed on the dielectric substrate 2. The dielectric substrate 2 is formed through an injection molding process. The internal cavity Q1 is connected to the first connection port 101 through the communication channel 102, so that a structure of the internal cavity Q1 can be simplified, facilitating formation of the internal cavity Q1.

With reference to a structure of an electronic device, when the resonant cavity antenna 10 is installed on a metal housing 20 of the electronic device, the second surface a2 of the dielectric substrate 2 is configured to face a metal casing 201, and the first surface a1 is a side that is of the dielectric substrate 2 and that is away from the metal housing 20. It may be considered that the first surface a1 is configured to face a screen 40 of the electronic device. When the resonant cavity antenna 10 is used in the electronic device having the metal housing 20, the metal casing 201 of the metal housing 20 may replace the metal ground 3 herein, in other words, the metal ground 3 may be the metal casing 201 or may be at least a portion of the metal casing 201.

Still refer to FIG. 3. The metal ground 3 is disposed on a side that is of the mechanical part 4 and that is away from the second surface a2 of the dielectric substrate 2. The pin 11 of the metal sheet 1 extends toward a side of the second surface a2 of the dielectric substrate 2, and is conductively connected to the metal ground 3 for grounding. The mechanical part 4 avoids interfering with the pin 11. The metal sheet 1 is configured to receive or transmit an electromagnetic wave in the resonant cavity antenna 10. At least a portion of the dielectric substrate 2 is located between the metal ground 3 and the metal sheet 1, so that a specific gap exists between the metal sheet 1 and the metal ground 3. A resonant cavity body of the resonant cavity antenna 10 may be formed between the metal sheet 1 and the metal ground 3. The electromagnetic wave transmitted or received by the resonant cavity antenna 10 may be reflected in the resonant cavity body a plurality of times, to implement a communication function of the resonant cavity antenna 10. Entire space between the metal sheet 1 and the metal ground 3 may be considered as the resonant cavity body of the resonant cavity antenna 10, and the resonant cavity body may include at least a portion of physical space occupied by the dielectric substrate 2. For example, the internal cavity Q1 of the resonant cavity antenna 10 is formed by the metal sheet 1 and the dielectric substrate 2 through fitting. It may be considered that the internal cavity Q1 is a portion of the resonant cavity body, or the internal cavity Q1 and the resonant cavity body share a portion of space, and formation of the internal cavity Q1 does not increase space occupied by an overall structure of the resonant cavity antenna 10.

It should be understood that the first surface a1 and the second surface a2 of the dielectric substrate 2 each are not necessarily a plane, and a structure such as a boss or a groove may be disposed according to a space design of the electronic device and a structural layout of the resonant cavity antenna 10. At least a portion of the top plate 12 of the metal sheet 1 is located on the first surface a1 of the dielectric substrate 2, and the pin 11 is partially located on the second surface a2 of the dielectric substrate 2. A position at which the pin 11 is disposed may be adjusted according to an application scenario. When the pin 11 corresponds to a position of the first connection port 101 and passes through the communication channel 102, the pin 11 is provided with at least one avoidance opening B. When the pin 11 is fastened to the dielectric substrate 2 through injection molding, the avoidance opening B may connect the internal cavity Q1 to the first connection port 101.

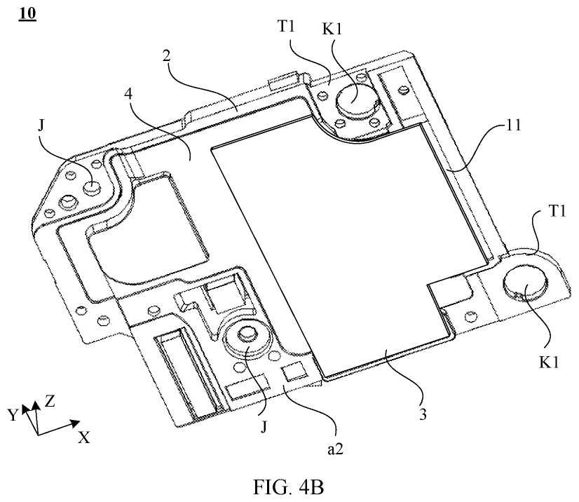

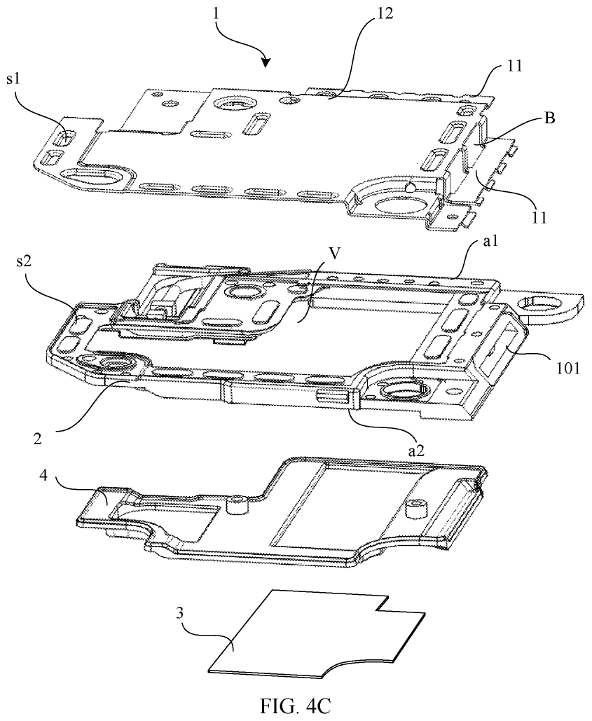

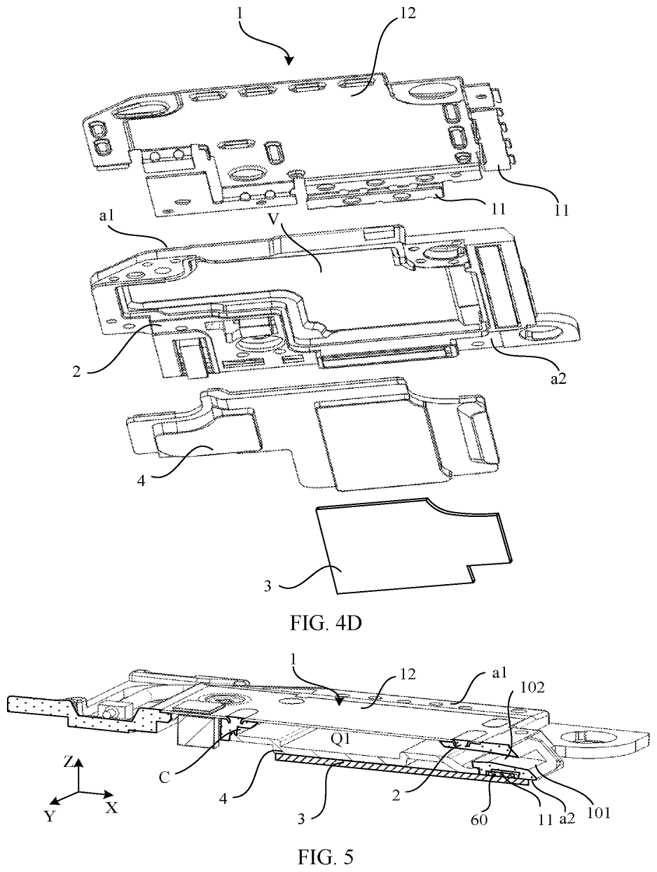

FIG. 4A to FIG. 4D show specific possible implementations of the resonant cavity antenna 10 shown in FIG. 3. FIG. 4A is a view of the resonant cavity antenna 10 in the Z direction from the top of the resonant cavity antenna 10 in a thickness direction. FIG. 4B is a view of the resonant cavity antenna 10 in the Z direction from the bottom of the resonant cavity antenna 10 in the thickness direction. FIG. 4C is an exploded view of the resonant cavity antenna 10 in the Z direction from the top of the resonant cavity antenna 10 in the thickness direction. FIG. 4D is an exploded view of the resonant cavity antenna 10 in the Z direction from the bottom of the resonant cavity antenna 10 in the thickness direction.

Refer to FIG. 4A and FIG. 4B together. The metal sheet 1 may be made of a steel sheet, the metal sheet 1 is fastened to the dielectric substrate 2 in an integrated injection molding manner, and the dielectric substrate 2 provides support for the metal sheet 1. In the Z direction, at least a portion of the top plate 12 of the metal sheet 1 is located on the first surface a1 of the dielectric substrate 2. In the Z direction, both the mechanical part 4 and the metal ground 3 are disposed on a side of the second surface a2 of the dielectric substrate 2. For example, the mechanical part 4 is located between the metal ground 3 and the dielectric substrate 2. The pin 11 of the metal sheet 1 is at least partially located on the second surface a2 of the dielectric substrate 2, and the pin 11 is not in contact with the mechanical part 4 on the second surface a2 of the dielectric substrate 2. The metal ground 3 is fastened to the second surface a2 of the dielectric substrate 2, and is at least partially stacked on a side that is of the mechanical part 4 and that is away from the first surface a1 of the dielectric substrate 2. The metal ground 3 is conductively connected to the pin 11 for grounding.

Refer to FIG. 4A and FIG. 4B together. To fasten the resonant cavity antenna 10 to the metal casing 201 or fasten the resonant cavity antenna 10 to another structure, the dielectric substrate 2 is further provided with several connection holes J. According to different functions, the connection holes J may run through the dielectric substrate 2, or may be blind holes. Each connection hole J is not communicated with the internal cavity Q1 formed between the metal sheet 1, the dielectric substrate 2, and the mechanical part 4. The resonant cavity antenna 10 further includes a first boss T1 configured to lap over the audio module 30 and a first through hole K1 provided on the first boss T1. The first boss T1 may be a portion of the dielectric substrate 2 or have an integrated structure with the dielectric substrate 2. A quantity of first bosses T1 is not limited. In this embodiment, one first boss T1 is separately disposed on two sides of the first connection port 101 in a Y direction. Further, a shape of the first boss T1 is not limited. The first boss T1 may be a protruding plate protruding from the dielectric substrate 2 in an X direction, or may be a groove formed at an edge of the dielectric substrate 2.

As shown in FIG. 4C and FIG. 4D, the resonant cavity antenna 10 includes the metal sheet 1, the dielectric substrate 2, the metal ground 3, and the mechanical part 4. The hollow V of the dielectric substrate 2 runs through the dielectric substrate 2 in the thickness direction of the dielectric substrate 2. The metal sheet 1 and the dielectric substrate 2 can be integrally formed through injection molding. The top plate 12 of the metal sheet 1 can cover an opening that is of the closed hollow V and that is located on the first surface a1. The mechanical part 4 is configured to be fastened to a side of the second surface a2 of the dielectric substrate 2 to cover an opening that is of the closed hollow V and that is located on the second surface a2. This allows for formation of the internal cavity Q1 of the resonant cavity antenna 10 between the metal sheet 1, the dielectric substrate 2, and the mechanical part 4. The internal cavity Q1 is relatively closed space. The hollow V communicates with the first connection port 101. In the resonant cavity antenna 10, the first connection port 101, the communication channel 102, and the first boss T1 that is configured to lap over the audio module 30 are formed on the dielectric substrate 2. The metal ground 3 is configured to be fastened to a side of the second surface a2 of the dielectric substrate 2, and the metal ground 3 is configured to be conductively connected to the pin 11 of the metal sheet 1.

Still refer to FIG. 4C. The metal sheet 1 includes the top plate 12 and a plurality of pins 11. Each pin 11 is connected to an edge of the top plate 12 and extends and bends toward a direction of the dielectric substrate 2. The top plate 12 is at least partially located on the first surface a1 of the dielectric substrate 2, and the plurality of pins 11 are configured to extend to be exposed from the second surface a2 of the dielectric substrate 2. One of the pins 11 corresponds to a position of the first connection port 101, and the pin 11 is provided with at least one avoidance opening B. When the pin 11 is fastened to the dielectric substrate 2 through injection molding, the avoidance opening B may connect an open slot C to the first connection port 101. A quantity and a shape of the pins 11 are not limited. A partial structure of the pin 11 located on the second surface a2 of the dielectric substrate 2 is close to a rectangle for example. The pin 11 is in a fold line shape. An end that is of the pin 11 and that is configured to connect to the metal ground 3 forms a contact plane, to be in surface contact with and connected to the metal ground 3, thereby enhancing connection reliability. The metal sheet 1 further has a plurality of injection molding holes s1, and the plurality of injection molding holes s1 may be distributed at an edge of the top plate 12. When the metal sheet 1 and the dielectric substrate 2 are formed by using an integrated injection molding process, melt liquid used for forming the dielectric substrate 2 may enter the plurality of injection molding holes s1. After the metal sheet 1 and the dielectric substrate 2 are cooled and molded, the dielectric substrate 2 includes a protrusion s2 filled in the injection molding hole s1, and the injection molding hole s1 of the metal sheet 1 and the protrusion s2 of the dielectric substrate 2 may form an interlocking connection structure, thereby enhancing structural strength of the resonant cavity antenna 10.

FIG. 5 shows a partial cross-sectional structure of the resonant cavity antenna 10. The top plate 12 of the metal sheet 1 covers the opening that is of the hollow V and that is located on the first surface a1 of the dielectric substrate 2. The mechanical part 4 is fastened to a side of the second surface a2 of the dielectric substrate 2, and covers the opening that is of the hollow V and that is located on the second surface a2. The top plate 12, the dielectric substrate 2, and the mechanical part 4 form the internal cavity Q1. The pin 11 of the metal sheet 1 is exposed from the second surface a2 of the dielectric substrate 2, and is conductively connected to the metal ground 3 for grounding. When the mechanical part 4 is fastened to the second surface a2 of the dielectric substrate 2, the mechanical part 4 avoids interfering with the pin 11 of the metal sheet 1, so that the pin 11 can be exposed from the second surface a2 of the dielectric substrate 2. The pin 11 may be conductively connected to the metal ground 3 through conductive foam 60. The conductive foam 60 serves an electrical connection function and can play a buffer role. In addition, a deformable property of the conductive foam 60 allows for tighter and more continuous connections between the conductive foam 60 and the pin 11 and between the conductive foam 60 and the metal ground 3, thereby achieving a better electrical connection effect.

Further, both the mechanical part 4 and the dielectric substrate 2 may be integrally formed with the metal sheet 1 through injection molding. Alternatively, the metal sheet 1 and the dielectric substrate 2 may be integrally formed through injection molding, and then the dielectric substrate 2 is fastened to the mechanical part 4 through welding or the like. It should be understood that the mechanical part 4 may be a plastic part made of a same material as the dielectric substrate 2. In this case, the mechanical part 4 may be connected to the dielectric substrate 2 through ultrasonic welding, glue dispensing, or the like.

In some embodiments, the mechanical part 4 may be made of a metal material, for example, a steel sheet. The mechanical part 4 made of the metal material is thinner. With an unchanged overall thickness of the resonant cavity antenna 10, space of the internal cavity Q1 may be increased. After the internal cavity Q1 of the resonant cavity antenna 10 communicates with the audio chamber Q2 of the audio module 30, audio volume expansion of the audio module 30 can be further implemented.

When the mechanical part 4 made of a metal material such as a steel sheet is used, the mechanical part 4 may be connected to the metal sheet 1 in a manner such as spot welding. In this case, the mechanical part 4 serves as the ground point for grounding of the metal sheet 1. In other words, the metal sheet 1 may be conductively connected to the metal ground 3 through the pin 11 for grounding, or the metal sheet 1 may be conductively connected to the metal ground 3 through the mechanical part 4 for grounding. Either or both of the two manners are selected. When the metal sheet 1 is not conductively connected to the metal ground 3 through the mechanical part 4 made of the metal material, the mechanical part 4 does not need to connect to the metal sheet 1 through spot welding, thereby reducing costs.

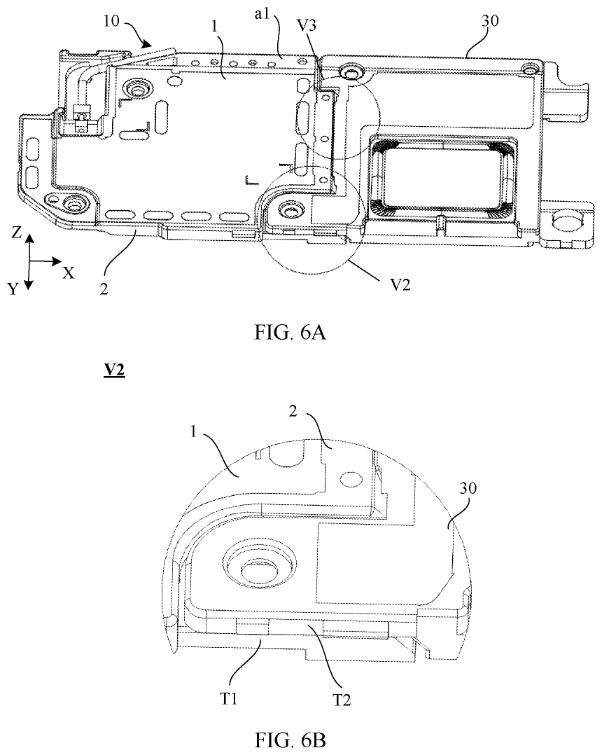

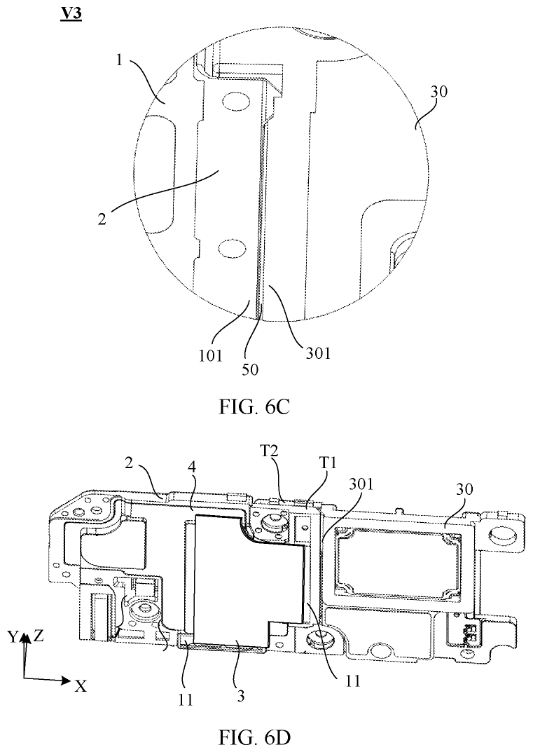

FIG. 6A shows a structure in which the resonant cavity antenna 10 fits with the audio module 30 in this embodiment. For example, the resonant cavity antenna 10 and the audio module 30 are arranged adjacent to each other in the X direction.

FIG. 6B is an enlarged view of details at V2 in FIG. 6A. Refer to FIG. 6A and FIG. 6B together. The first boss T1 is disposed on a side that is of the resonant cavity antenna 10 and that faces the audio module 30, and the second boss T2 is disposed on a side that is of the audio module 30 and that faces the resonant cavity antenna 10. The first boss T1 may lap over the second boss T2 in a Z direction of the resonant cavity antenna 10. The resonant cavity antenna 10 may be fastened to the audio module 30 by using a screw sequentially passing through the first boss T1 and the second boss T2. The resonant cavity antenna 10 and the audio module 30 may be further fastened to the metal casing 201 or another structure by using a screw. Certainly, the resonant cavity antenna 10 may alternatively be fastened to the audio module 30 in another manner. This is not limited in this application. Structures of the first boss T1 and the second boss T2 are merely examples.

FIG. 6C is an enlarged view of details at V3 in FIG. 6A. As shown in FIG. 6C, the first connection port 101 is formed on a side that is of the resonant cavity antenna 10 and that faces the audio module 30, and the first connection port 101 is configured to communicate with the internal cavity Q1 of the resonant cavity antenna 10. The second connection port 301 is formed on a side that is of the audio module 30 and that faces the resonant cavity antenna 10, and the second connection port 301 is configured to communicate with the audio chamber Q2 of the audio module 30. The first connection port 101 is connected to and communicated with the second connection port 301, so that the internal cavity Q1 can communicate with the audio chamber Q2, thereby implementing a design in which the resonant cavity antenna 10 and the audio module 30 share a cavity. For example, to enhance connection reliability and sealing performance, the first connection port 101 is connected to the second connection port 301 by using a sealing ring 50. When the first connection port 101 is connected to the second connection port 301, the sealing ring 50 is pressed between an end face of the first connection port 101 and an end face of the second connection port 301, and the sealing ring 50 surrounds a channel formed by communication between the first connection port 101 and the second connection port 301 for sealing. The sealing ring 50 may be of a structure such as sealing foam or a sealing rubber ring. Certainly, a sealed connection between the first connection port 101 and the second connection port 301 may alternatively be implemented in another manner such as sealant bonding to implement a sealed communication. It should be understood that the internal cavity Q1 is an internal structure of the resonant cavity antenna 10, and the audio chamber Q is an internal structure of the audio module 30. Therefore, neither the internal cavity Q1 nor the audio chamber Q2 is shown herein.

With reference to FIG. 6A, FIG. 6D shows a fitting structure that is of the resonant cavity antenna 10 and the audio module 30 and that is on a side of the second surface a2 of the dielectric substrate 2 in the Z direction. As shown in FIG. 6D, the metal sheet 1 of the resonant cavity antenna 10 has at least one pin 11 that is exposed from a side that is of the dielectric substrate 2 and that faces the metal casing 201. These pins 11 may be used as ground points of the metal sheet 1 to connect to the metal ground 3. When the resonant cavity antenna 10 is further fastened to the metal casing 201, a buffer structure such as insulation foam may be added between the dielectric substrate 2 and the metal casing 201 to protect the resonant cavity antenna 10.

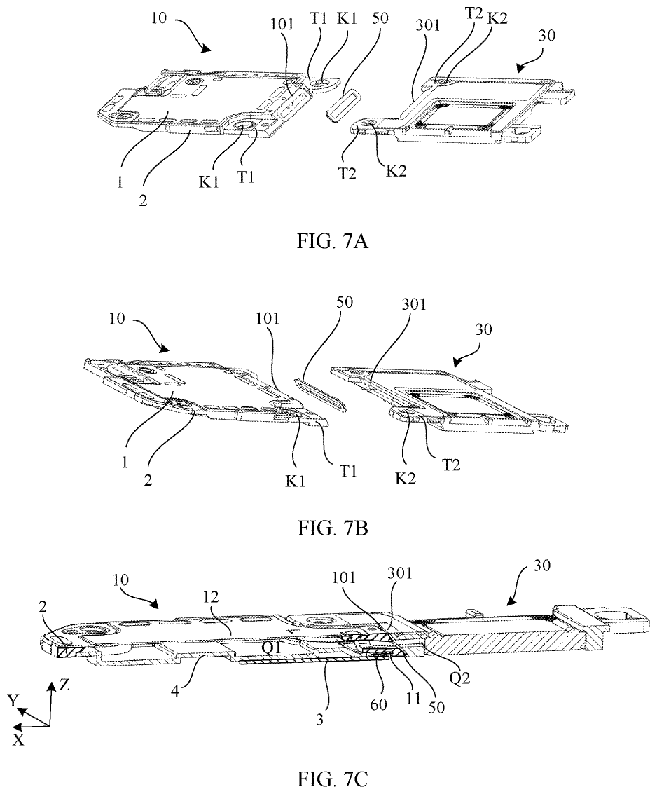

Based on the fitting structures of the resonant cavity antenna 10 and the audio module 30 shown in FIG. 6A to FIG. 6D, FIG. 7A and FIG. 7B show structures in which the resonant cavity antenna 10 is separated from the audio module 30.

Refer to FIG. 7A and FIG. 7B together. The first connection port 101 of the resonant cavity antenna 10 may be connected to the second connection port 301 of the audio module 30 through the sealing ring 50, to expand a volume of an acoustic cavity of the audio module 30 and optimize audio effect. For example, two first bosses T1 are formed on a side that is of the resonant cavity antenna 10 and that is configured to connect to the audio module 30. The two first bosses T1 are configured to lap over the audio module 30. Each first boss T1 is correspondingly provided with a first through hole K1 that runs through the first boss T1. A second through hole K2 that runs through a second boss T2 is provided on the second boss T2 that is configured to lap over the first boss T2. When the first boss T1 laps over the second boss T2, the first through hole K1 can correspond to and communicate with the second through hole K2 in the thickness direction of the resonant cavity antenna 10. In this case, a connector such as a bolt or a screw may sequentially pass through the first through hole K1 and the second through hole K2 to be fastened to the metal casing 201 of the electronic device.

For example, in an arrangement direction of the audio module 30 and the resonant cavity antenna 10, an end face that is of the first connection port 101 and that is used for connection to the second connection port 301 and an end face that is of the second connection port 301 and that is used for connection to the first connection port 101 are inclined and parallel to each other. The end face of the first connection port 101 of the resonant cavity antenna 10 is inclined and faces a side away from the metal casing 201, and the end face of the second connection port 301 of the audio module 30 is inclined and faces a side close to the metal casing 201. When the audio module 30 and the resonant cavity antenna 10 are installed, the sealing ring 50 may be first bonded and fastened to the first connection port 101 of the resonant cavity antenna 10. The sealing ring 50 surrounds the first connection port 101, and then presses the second connection port 301 of the audio module 30 to the second connection port 301 of the resonant cavity antenna 10 in a direction pointing from the screen 40 of the electronic device to the metal casing 201, so that the first connection port 101 and the second connection port 301 are connected in a sealed manner through the sealing ring 50. The end face of the first connection port 101 and the end face of the second connection port 301 are inclined and parallel to each other. During press-fitting, an external force may be used to enhance connection tightness between the first connection port 101 and the second connection port 301. After the resonant cavity antenna 10 and the audio module 30 are fastened to the metal casing 201 by using a fastener such as a screw, the end face of the second connection port 301 of the audio module 30 presses the end face of the first connection port 101 of the resonant cavity antenna 10 toward the metal casing 201. This ensures that a specific pressing force is always maintained between the first connection port 101 and the second connection port 301, thereby guaranteeing a sealed connection between the first connection port 101 and the second connection port 301 through the sealing ring 50.

A tilting manner of the end face of the first connection port 101 and a tilting manner of the end face of the second connection port 301 may be interchanged. In other words, it may alternatively be a structure in which the end face of the first connection port 101 presses toward the end face of the second connection port 301. Certainly, the first connection port 101 of the resonant cavity antenna 10 may alternatively be fastened to the second connection port 301 of the audio module 30 in another manner. Details are not described herein again.

FIG. 7C is a partial cross-sectional structure of a connection between the resonant cavity antenna 10 and the audio module 30 according to an embodiment of this application. As shown in FIG. 7C, the resonant cavity antenna 10 has the internal cavity Q1. For example, the dielectric substrate 2 of the resonant cavity antenna 10, the top plate 12 of the metal sheet 1, and the mechanical part 4 work with each other to form the internal cavity Q1, and the internal cavity Q1 is relatively sealed space. The internal cavity Q1 being relatively sealed may be considered as that other portions of the internal cavity Q1 are sealed except the portion communicating with the first connection port 101. The pin 11 of the metal sheet 1 is exposed from a bottom surface that is of the dielectric substrate 2 and that faces the metal casing 201 and is conductively connected to the metal ground 3 through the conductive foam 60, so that the metal sheet 1 and the metal casing 201 form a resonant cavity of the resonant cavity antenna 10. At least a portion of the internal cavity Q1 is located in the resonant cavity of the resonant cavity antenna 10. It may be considered that the internal cavity Q1 and the resonant cavity share a portion of space, and formation of the internal cavity Q1 does not increase space occupied by an overall structure of the resonant cavity antenna 10. It should be understood that a structure of the mechanical part 4 may be irregular, and may be an abnormal-shaped structure adaptively according to an application scenario. An abnormal shape of the mechanical part 4 affects a shape of the internal cavity Q1. For example, a structure such as a groove or a protrusion may be formed on an inner wall of the mechanical part 4 of the resonant cavity antenna 10 shown in FIG. 7C.

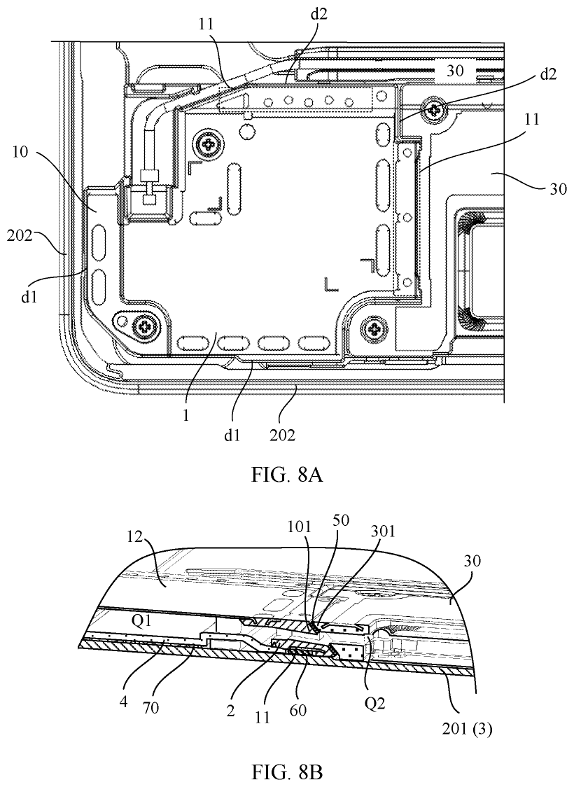

When the resonant cavity antenna 10 provided in this embodiment is used in the electronic device having the metal housing 20, the metal casing 201 of the metal housing 20 may replace the metal ground 3 of the resonant cavity antenna 10. FIG. 8A shows an example in which the resonant cavity antenna 10 is disposed at a corner of the metal housing 20. The resonant cavity antenna 10 includes at least one first side edge d1 and at least one second side edge d2. The first side edge d1 is adjacent to a metal middle frame 202 of the metal housing 20, and the second side edge d2 is opposite to the metal middle frame 202 of the metal housing 20. It may be considered that the second side edge d2 is a side edge that is of the resonant cavity antenna 10 and that is away from the metal middle frame 202. The resonant cavity antenna 10 is approximately rectangular. For example, two pins 11 included in the metal sheet 1 are respectively disposed near two second side edges d2 that are of the resonant cavity antenna 10 and that are away from the metal middle frame 202. The two dashed-line boxes show positions of the pins 11 of the metal sheet 1, and the two rectangular pins 11 are respectively opposite to the two metal middle frames 202. When the two pins 11 are connected to the metal casing 201 that is used as the metal ground 3, the metal sheet 1 and the metal casing 201 form the approximately cuboid-shaped resonant cavity. The metal casing 201, the metal middle frame 202, and the two pins 11 are respectively equivalent to at least a portion of a side wall of the resonant cavity of the resonant cavity antenna 10, so that antenna performance can be optimized.

FIG. 8B is a partial cross-sectional diagram in which the resonant cavity antenna 10 and the audio module 30 fit with the metal casing 201. As shown in FIG. 8B, the pin 11 of the metal sheet 1 is exposed from the dielectric substrate 2 and is electrically connected to the metal casing 201 through the conductive foam 60 or another conductive connector. Buffer foam 70 may be filled between the dielectric substrate 2 and the metal casing 201, to improve shockproof effect and protect the resonant cavity antenna 10. The audio module 30 is fastened to the metal casing 201, and the second connection port 301 of the audio module 30 is connected to the first connection port 101 in a sealed manner through the sealing ring 50, to implement communication between the audio chamber Q2 and the internal cavity Q1. Certainly, a buffer structure such as the buffer foam may alternatively be filled between the audio module 30 and the metal casing 201, to protect the audio module 30.

### Embodiment 2

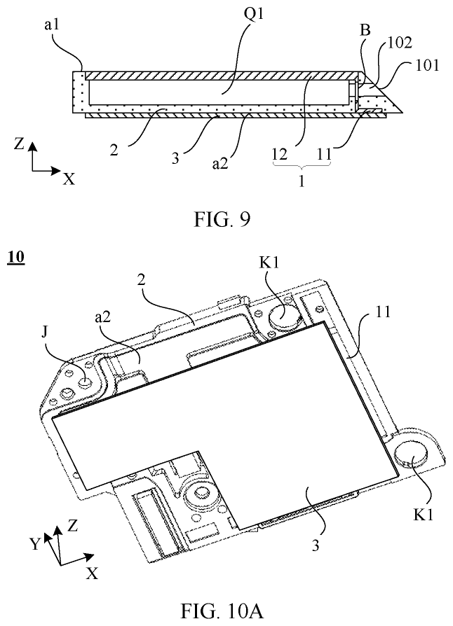

FIG. 9 is a simplified diagram of a cross-sectional structure of a resonant cavity antenna 10. The resonant cavity antenna 10 includes a metal sheet 1, a dielectric substrate 2, and a metal ground 3. Compared with the resonant cavity antenna 10 provided in Embodiment 1, the resonant cavity antenna 10 provided in this embodiment does not include a mechanical part 4, and the metal sheet 1 and the dielectric substrate 2 can work with each other to form the internal cavity Q1. In a Z direction, the dielectric substrate 2 includes a first surface a1 and a second surface a2 that are opposite to each other. At least a portion of the metal sheet 1 is located on the first surface a1 of the dielectric substrate 2. Further, the dielectric substrate 2 has an open slot C with an opening located on the first surface a1. A top plate 12 of the metal sheet 1 can cover the first surface a1 of the dielectric substrate 2 to close the opening of the open slot C, so that the metal sheet 1 and the dielectric substrate 2 form a closed internal cavity Q1.

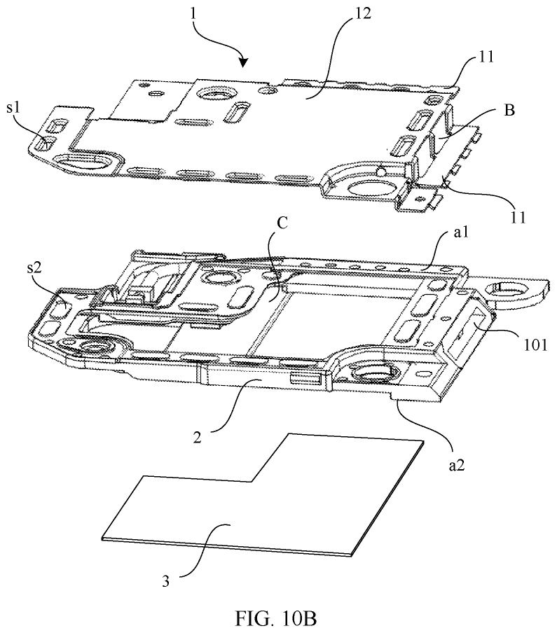

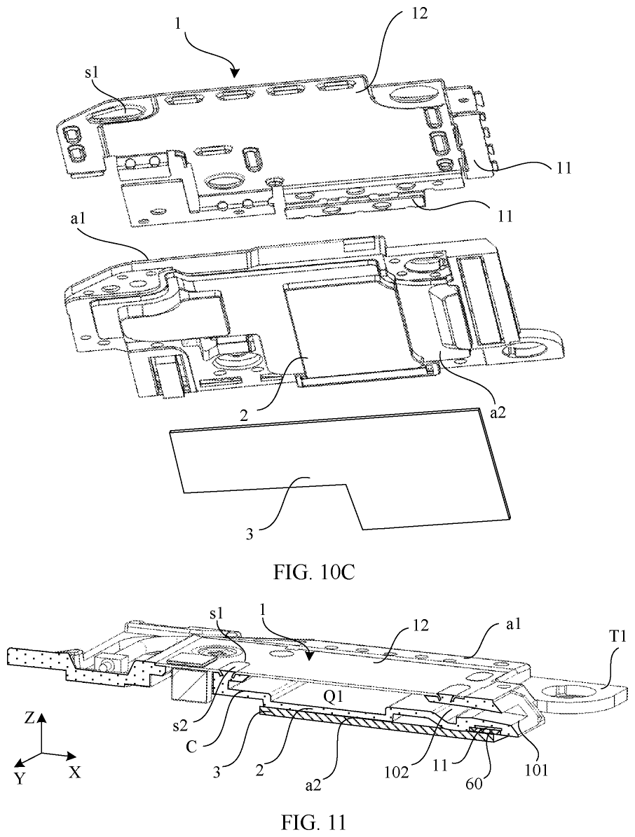

FIG. 10A to FIG. 10C show specific possible implementations of the resonant cavity antenna 10 shown in FIG. 9. FIG. 10A is a view of the resonant cavity antenna 10 in the Z direction from the bottom of the resonant cavity antenna 10 in a thickness direction. FIG. 10B is an exploded view of the resonant cavity antenna 10 in the Z direction from the top of the resonant cavity antenna 10 in the thickness direction. FIG. 10C is an exploded view of the resonant cavity antenna 10 in the Z direction from the bottom of the resonant cavity antenna 10 in the thickness direction. For a structure of the resonant cavity antenna 10 in the Z direction from the top of the resonant cavity antenna 10 in the thickness direction, refer to the similar structure shown in FIG. 4A in Embodiment 1. This is not exemplified herein again.

As shown in FIG. 10A, a portion of a pin 11 of the metal sheet 1 is located on the second surface a2 of the dielectric substrate 2, and the pin 11 is connected to the metal ground 3 to implement grounding of the metal sheet 1.

As shown in FIG. 10B, an open slot C is formed on the dielectric substrate 2, and an opening of the open slot C is located on the first surface a1. The metal sheet 1 can be fastened to the first surface a1 of the dielectric substrate 2 and seal the opening of the open slot C, so that the internal cavity Q1 may be formed between the metal sheet 1 and the dielectric substrate 2. The internal cavity Q1 is relatively closed space. A first connection port 101 is formed on an outer surface that is of the dielectric substrate 2 and that is configured to face an audio module 30, and the first connection port 101 communicates with the open slot C.

FIG. 11 is a diagram of a partial cross-sectional structure of the resonant cavity antenna 10. The top plate 12 of the metal sheet 1 covers the opening of the open slot C of the dielectric substrate 2, and the top plate 12 fits with the open slot C of the dielectric substrate 2 to form the relatively closed internal cavity Q1. The first connection port 101 is formed on the dielectric substrate 2, and the first connection port 101 communicates with the internal cavity Q1 through a communication channel 102. The pin 11 of the metal sheet 1 is exposed from the second surface a2 of the dielectric substrate 2. The pin 11 may be conductively connected to the metal ground 3 through conductive foam 60. The conductive foam 60 serves an electrical connection function and can play a buffer role. In addition, a deformable property of the conductive foam 60 allows for tighter and more continuous connections between the conductive foam 60 and the pin 11 and between the conductive foam 60 and the metal ground 3, thereby achieving a better electrical connection effect.

It should be understood that a structure of the dielectric substrate 2 may be irregular, and may be an abnormal-shaped structure adaptively according to an application scenario. An abnormal shape of the dielectric substrate 2 affects a shape of the internal cavity Q1. For example, a structure such as a groove or a protrusion may be formed on an inner wall of the dielectric substrate 2 of the resonant cavity antenna 10 shown in FIG. 7C.

### Embodiment 3

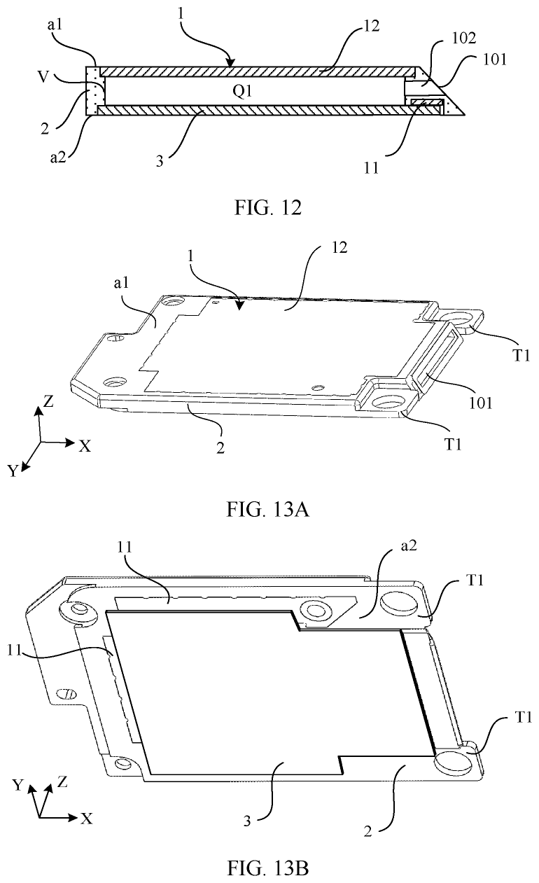

FIG. 12 is a simplified diagram of a cross-sectional structure of a resonant cavity antenna 10. The resonant cavity antenna 10 includes a metal sheet 1, a dielectric substrate 2, and a metal ground 3. Compared with those included in the resonant cavity antenna 10 provided in Embodiment 2, the metal sheet 1, the dielectric substrate 2, and the metal ground 3 included in the resonant cavity antenna 10 provided in this embodiment can work with each other to form the internal cavity Q1. In a Z direction, the dielectric substrate 2 includes a first surface a1 and a second surface a2 that are opposite to each other. Further, the dielectric substrate 2 has a hollow V that runs through the first surface a1 and the second surface a2. A top plate 12 of the metal sheet 1 can cover an opening on the first surface a1 of the dielectric substrate 2, and the metal ground 3 can cover an opening on the second surface a2 of the dielectric substrate 2, so that the metal sheet 1, the dielectric substrate 2, and the metal ground 3 form the closed internal cavity Q1.

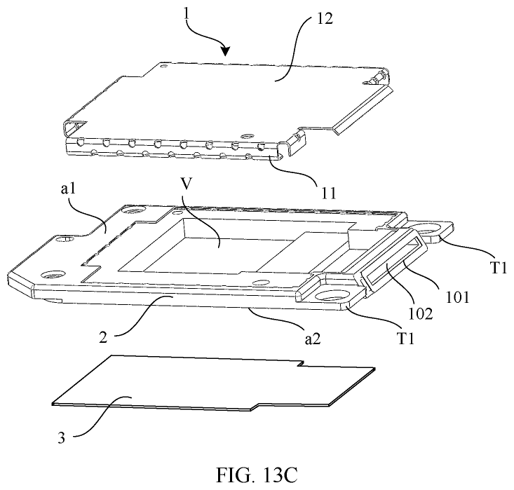

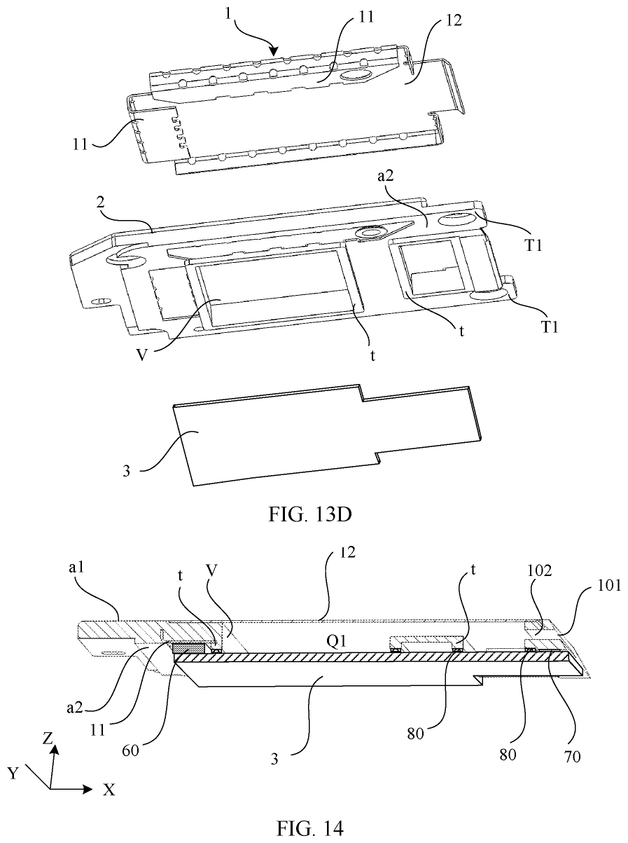

FIG. 13A to FIG. 13D show specific possible implementations of the resonant cavity antenna 10 shown in FIG. 12. FIG. 13A shows a structure of the resonant cavity antenna 10 in the Z direction from the top of the resonant cavity antenna 10 in a thickness direction. FIG. 13B shows a structure of the resonant cavity antenna 10 in the Z direction from the bottom of the resonant cavity antenna 10 in the thickness direction. FIG. 13C is an exploded view in the Z direction from the top of the resonant cavity antenna 10 in the thickness direction. FIG. 13D is an exploded view in the Z direction from the bottom of the resonant cavity antenna 10 in the thickness direction.

As shown in FIG. 13A and FIG. 13B, the metal sheet 1 is fastened to the dielectric substrate 2 through an integrated injection molding process. FIG. 13A shows the top plate 12 that is of the metal sheet 1 and that is located on the first surface a1 of the dielectric substrate 2. FIG. 13B shows a pin 11 that is of the metal sheet 1 and that is located on the second surface a2 of the dielectric substrate 2. The metal ground 3 is fastened to the second surface a2 of the dielectric substrate 2, and the metal ground 3 is conductively connected to the pin 11.

As shown in FIG. 13C and FIG. 13D, for example, the dielectric substrate 2 has the hollow V through which the first surface a1 communicates with second openings v2 on the second surface a2. The top plate 12 of the metal sheet 1 can cover and seal the opening that is of the hollow V and that is located on the first surface a1, and the metal ground 3 can cover and seal the opening that is of the hollow V and that is located on the second surface a2. A quantity of openings that are of the hollow V and that are located on the first surface a1 and a quantity of openings that are of the hollow V and that are located on the second surface a2 are not limited. For example, there is one opening that is of the hollow V and that is located on the first surface a1, and there are two openings that are of the hollow V and that are located on the second surface a2. The hollow V communicates with a first connection port 101. In the resonant cavity antenna 10, the first connection port 101, a communication channel 102, and a first boss T1 that is configured to lap over the audio module 30 are formed on the dielectric substrate 2.

As shown in FIG. 13D, on the second surface a2 of the dielectric substrate 2, the dielectric substrate 2 may form an annular boss t surrounding the opening that is of the hollow V and that is located on the second surface a2. At least a portion of the annular boss t protrudes from the second surface a2 of the dielectric substrate 2. The annular boss t is configured to connect to the metal ground 3 in a sealed manner, to seal the opening that is of the hollow V and that is located on the second surface a2. When there are a plurality of openings that are of the hollow V and that are located on the second surface a2, surfaces that are away from the metal sheet 1 and that are of annular bosses t corresponding to all the openings that are of the hollow V and that are located on the second surface a2 may be designed to be coplanar, so that the metal ground 3 can seal the plurality of openings at a same time. This can simplify a process and improve sealing performance.

FIG. 14 shows a partial cross-sectional structure of the resonant cavity antenna 10. As shown in FIG. 14, after the metal sheet 1 and the dielectric substrate 2 are formed through injection molding, the top plate 12 of the metal sheet 1 covers and seals the opening that is of the hollow V and that is located on the first surface a1, the metal ground 3 is fastened to the second surface a2 of the dielectric substrate 2 and covers and seals the opening that is of the hollow V and that is located on the second surface a2. The pin 11 of the metal sheet 1 extends to the second surface a2 of the dielectric substrate 2 and is conductively connected to the metal ground 3. The metal sheet 1, the hollow V of the dielectric substrate 2, and the metal ground 3 form the closed internal cavity Q1.

Further, on a side of the second surface a2 of the dielectric substrate 2, the annular boss t disposed around the opening that is of the hollow V and that is located on the second surface a2 may be connected to the metal ground 3 in a sealed manner through a structure such as sealing foam 80. The pin 11 of the metal sheet 1 may be conductively connected to the metal ground 3 through conductive foam 60. A structure such as buffer foam 70 may be filled between the dielectric substrate 2 and the metal ground 3 to protect the resonant cavity antenna 10.

After the first connection port 101 of the resonant cavity antenna 10 communicates with an audio chamber of the audio module 30, the internal cavity Q1 can be used as a portion of an acoustic cavity to expand a volume of the acoustic cavity. It should be understood that, a communication structure between the resonant cavity antenna 10 and the audio module 30 is similar to that in Embodiment 1, and a difference lies in a specific implementation of the internal cavity Q1. Therefore, a fitting structure between the resonant cavity antenna 10 and the audio module 30 is not exemplified herein. Certainly, when the resonant cavity antenna 10 is used in an electronic device having a metal housing 20, a metal casing 201 of the metal housing 20 may replace the metal ground 3 in the resonant cavity antenna 10. The fitting manner is also further described in Embodiment 1. Details are not described herein again.

### Embodiment 4

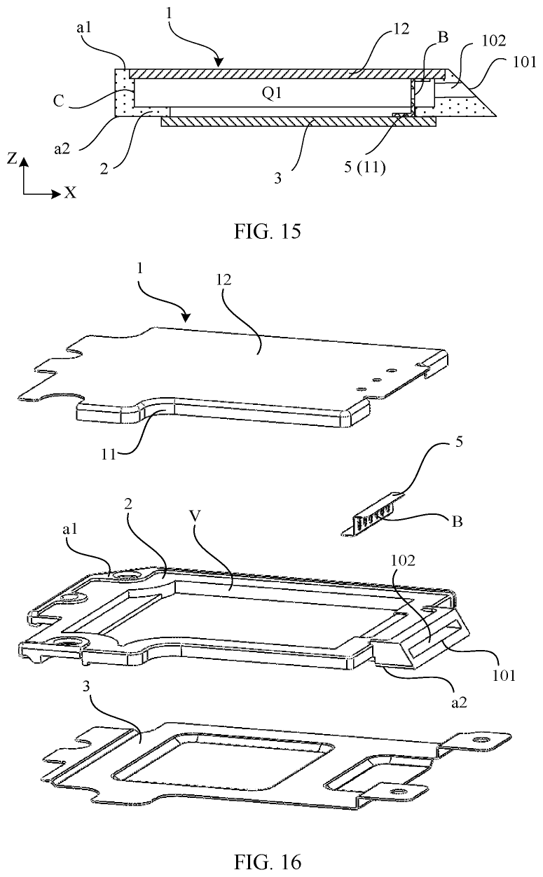

FIG. 15 is a simplified diagram of a cross-sectional structure of a resonant cavity antenna 10. The resonant cavity antenna 10 includes a metal sheet 1, a dielectric substrate 2, and a metal ground 3. Compared with those in the resonant cavity antenna 10 provided in Embodiment 3, the metal sheet 1 and the metal ground 3 in the resonant cavity antenna 10 provided in this embodiment are connected to each other through a connector 5. The connector 5 herein is a structure independent of the metal sheet 1, and the connector 5 may be considered as a split pin 11 of the metal sheet 1. Two ends of the connector 5 are respectively connected to a top plate 12 of the metal sheet 1 and the metal ground 3, and the connector 5 is independent of the top plate 12 of the metal sheet 1 and the metal ground 3.

FIG. 16 is an exploded view of a specific possible implementation of the resonant cavity antenna 10 shown in FIG. 15. The connector 5 is conductive and may be made of a metal material. The connector 5 is independent of the metal sheet 1 and the metal ground 3. The top plate 12 of the metal sheet 1 may be connected to the metal ground 3 through the connector 5. The connector 5 is bent in shape. A bent surface at one end of the connector 5 is configured to be in surface contact with and connected to the top plate 12 of the metal sheet 1, and a bent surface at the other end is configured to be in surface contact with and connected to the metal ground 3. For example, the connector 5 is located on a side of a connection port 101. The connector 5 is provided with an avoidance hole B for communication between space on two sides of the connector 5. Certainly, the metal sheet 1 may further include the pin 11 in Embodiment 2, and is conductively connected to the metal ground 3 through the pin 11.

FIG. 17 is a diagram of a partial cross-sectional structure of the resonant cavity antenna 10. The top plate 12 of the metal sheet 1 is disposed on a first surface a1 of the dielectric substrate 2 and covers and seals an opening that is of a hollow V and that is located on the first surface a1. The metal ground 3 is disposed on a second surface a2 of the dielectric substrate 2 and covers an opening that is of the hollow V and that is located on the second surface a3. The top plate 12 of the metal sheet 1, the dielectric substrate 2, and the metal ground 3 enclose an internal cavity Q1. The top plate 12 of the metal sheet 1 may be conductively connected to the metal ground 3 through the connector 5, or may be conductively connected to the metal ground 3 through the pin 11 of the metal sheet 1. Certainly, in the resonant cavity antenna 10, the metal sheet 1 may alternatively not be provided with the pin 11, thereby simplifying a structure. For example, the connector 5 is located on a side of a first connection port 101. The avoidance hole B on the connector 5 may allow the internal cavity Q1 to communicate with the first connection port 101 through a communication channel 102. The top plate 12 of the metal sheet 1 may be connected to the connector 5 through spot welding, and the metal ground 3 may also be connected to the connector 5 through spot welding.

After the first connection port 101 of the resonant cavity antenna 10 communicates with an audio chamber of an audio module 30, the internal cavity Q1 can be used as a portion of an acoustic cavity to expand a volume of the acoustic cavity. It should be understood that, a communication structure between the resonant cavity antenna 10 and the audio module 30 is similar to that in Embodiment 1, and a difference lies in a specific implementation of the internal cavity Q1. Therefore, a fitting structure between the resonant cavity antenna 10 and the audio module 30 is not exemplified herein. Certainly, when the resonant cavity antenna 10 is used in an electronic device having a metal housing 20, a metal casing 201 of the metal housing 20 may replace the metal ground 3 in the resonant cavity antenna 10. The fitting manner is also further described in Embodiment 1. Details are not described herein again.

### Embodiment 5

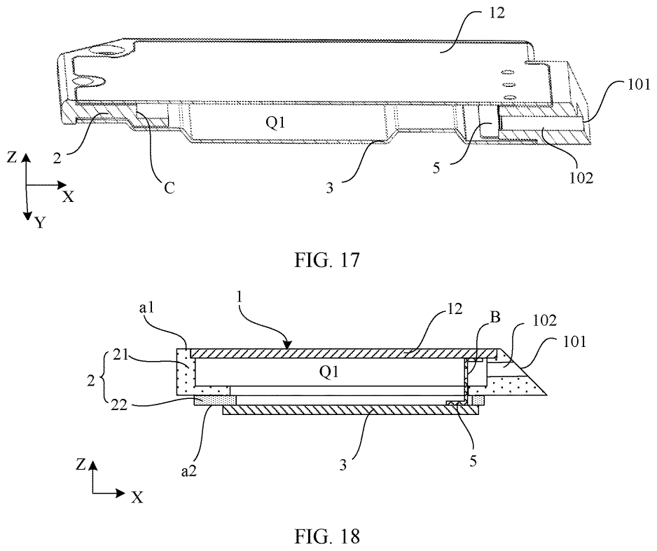

FIG. 18 is a simplified diagram of a cross-sectional structure of a resonant cavity antenna 10. The resonant cavity antenna 10 includes a metal sheet 1, a dielectric substrate 2, and a metal ground 3. Compared with the resonant cavity antenna 10 provided in Embodiment 4, in the resonant cavity antenna 10 provided in this embodiment, the dielectric substrate 2 includes a first substrate 21 and a second substrate 22. The first substrate 21 and the second substrate 22 are connected to form the dielectric substrate 2. A surface that is of the first substrate 21 and that is away from the second substrate 22 may be considered as a first surface a1 of the dielectric substrate 2, and a surface that is of the second substrate 22 and that is away from the first substrate 21 may be considered as a second surface a2 of the dielectric substrate 2. The first substrate 21 and the second substrate 22 each are of a frame-shaped structure. A structure formed by connection between the first substrate 21 and the second substrate 22 is similar to the dielectric substrate 2 in Embodiment 4. The metal sheet 1 may be connected to the metal ground 3 through a connector 5, and two ends of the connector 5 are respectively connected between the top plate 12 of the metal sheet 1 and the metal ground 3.

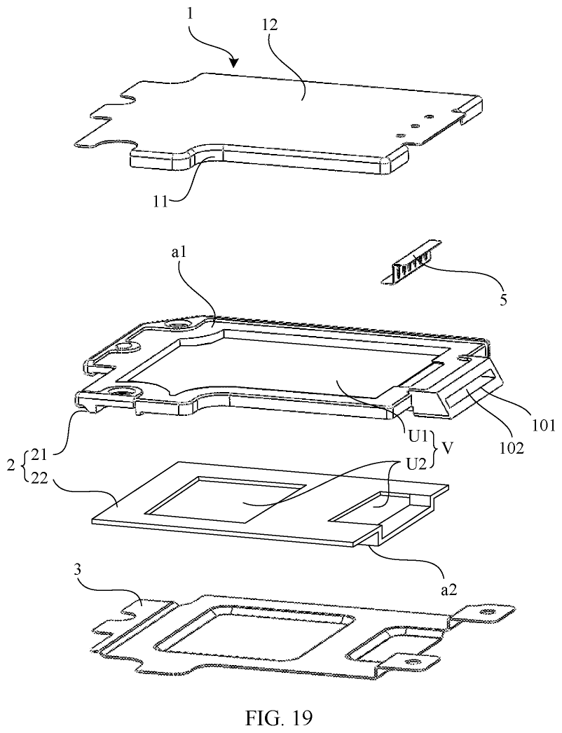

FIG. 19 is an exploded view of a possible implementation of the resonant cavity antenna 10 shown in FIG. 18. The first substrate 21 has a first through groove U1 that runs through the first substrate 21, and the second substrate 22 has a second through groove U2 that runs through the second substrate 22. The first substrate 21 and the second substrate 22 are connected to form the dielectric substrate 2, and the first through groove U1 and the second through groove U2 can communicate to form a hollow V. It may be considered that the surface that is of the first substrate 21 and that is away from the second substrate 22 is the first surface a1 of the dielectric substrate 2, and the surface that is of the second substrate 22 and that is away from the first substrate 21 is the second surface a2 of the dielectric substrate 2. The metal sheet 1 is configured to be integrally formed with the first substrate 21 through injection molding and seal an opening that is of the first through groove U1 and that is located on the first surface a1. The metal ground 3 is configured to be integrally formed with the second substrate 22 through injection molding and seal an opening that is of the second through groove U2 and that is located on the second surface a2. Next, the first substrate 21 is connected to the second substrate 22 in a manner of welding or the like. Finally, the metal sheet 1, the first substrate 21, the second substrate 22, and a structure 3 form an internal cavity Q1. In the resonant cavity antenna 10, the dielectric substrate 2 features a split design including the first substrate 21 and the second substrate 22, so that a manufacturing process can be simplified.

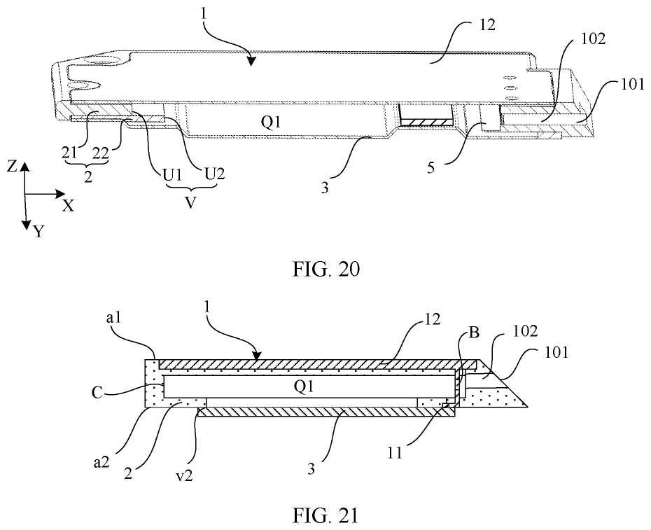

FIG. 20 is a diagram of a partial cross-sectional structure of the resonant cavity antenna 10. The metal sheet 1 may be integrally formed with the first substrate 21 through injection molding, and cover and seal the opening that is of the first through groove U1 and that is located on the first surface a1. The metal ground 3 may be integrally formed with the second substrate 22 through injection molding, and cover and seal the opening that is of the second through groove U2 and that is located on the second surface a2. The first substrate 21 may be fastened to the second substrate 22 in a manner of welding or the like, and the first penetration U1 and the second penetration U2 may communicate to form the hollow V of the dielectric substrate 2. The metal sheet 1, the first substrate 21, the second substrate 22, and a mechanical part 4 form the internal cavity Q. The top plate 12 of the metal sheet 1 may be conductively connected to the mechanical part 4 through the connector 5, or may be conductively connected to the mechanical part 4 through a pin 11 of the metal sheet 1.

The first substrate 21 and the second substrate 22 may be connected to form the dielectric substrate 2 in a manner of ultrasonic welding, glue dispensing, or the like. This manner may be further applied to the dielectric substrate 2 shown in Embodiment 1. When the mechanical part 4 is of a metal structure such as a steel sheet, the mechanical part 4 may be integrally formed with the substrate 22 through injection molding. The metal sheet 1, the first substrate 21, the second substrate 22, and the mechanical part 4 form the internal cavity Q1.

After a first connection port 101 of the resonant cavity antenna 10 communicates with an audio chamber of an audio module 30, the internal cavity Q1 can be used as a portion of an acoustic cavity to expand a volume of the acoustic cavity. It should be understood that, a communication structure between the resonant cavity antenna 10 and the audio module 30 is similar to that in Embodiment 1, and a difference lies in a specific implementation of the internal cavity Q1. Therefore, a fitting structure between the resonant cavity antenna 10 and the audio module 30 is not exemplified herein. Certainly, when the resonant cavity antenna 10 is used in an electronic device having a metal housing 20, a metal casing 201 of the metal housing 20 may replace the metal ground 3 in the resonant cavity antenna 10. The fitting manner is also further described in Embodiment 1. Details are not described herein again.

### Embodiment 6

FIG. 21 is a simplified diagram of a cross-sectional structure of a resonant cavity antenna 10. The resonant cavity antenna 10 includes a metal sheet 1, a dielectric substrate 2, and a metal ground 3. Compared with the structure of the resonant cavity antenna 10 shown in Embodiment 1, a difference lies in that in this embodiment, the mechanical part 4 is omitted, and the metal sheet 1 and the metal ground 3 work with each other to form the internal cavity Q1. In a Z direction, the dielectric substrate 2 includes a first surface a1 and a second surface a2 that are opposite to each other. The metal sheet 1 may be made of a steel sheet, and the metal sheet 1 is fastened to the dielectric substrate 2 in an integrated injection molding manner. A top plate 12 of the metal sheet 1 is located on the first surface a1 of the dielectric substrate 2. The dielectric substrate 2 has an open slot C, and an opening of the open slot C is located on the second surface a2. The metal ground 3 is fastened to a side of the second surface a2 of the dielectric substrate 2, and seals the opening of the open slot C, so that the dielectric substrate 2 and the metal ground 3 form an internal cavity Q1.

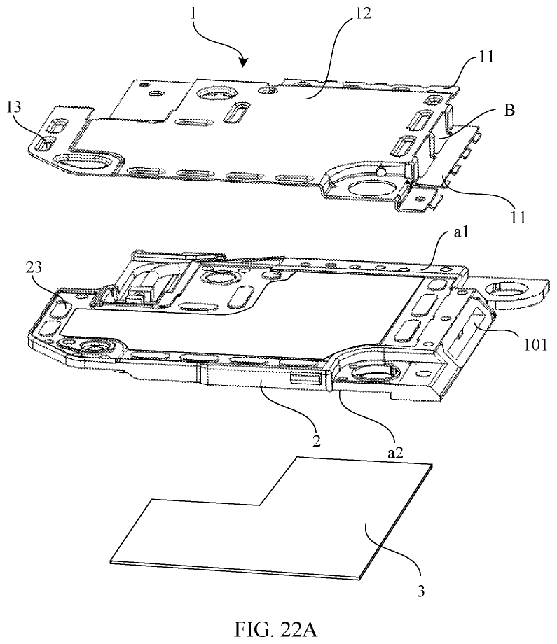

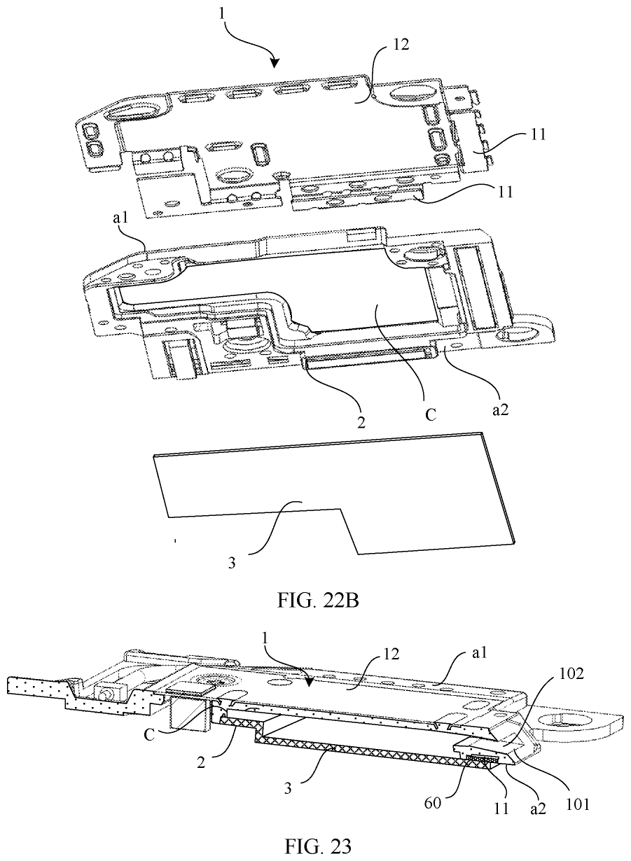

FIG. 22A and FIG. 22B are exploded views of a possible implementation of the resonant cavity antenna 10 shown in FIG. 21. FIG. 23 is a diagram of a partial cross-sectional structure of the resonant cavity antenna 10. FIG. 22A is a view of the resonant cavity antenna 10 in the Z direction from the top of the resonant cavity antenna 10 in a thickness direction. FIG. 22B is a view of the resonant cavity antenna 10 in the Z direction from the bottom of the resonant cavity antenna 10 in the thickness direction. The first surface a1 of the dielectric substrate 2 is closed. The opening of the open slot C of the dielectric substrate 2 is located on the second surface a2. The metal ground 3 is fastened to the dielectric substrate 2 and seals the opening of the open slot C. The relatively closed internal cavity Q1 can be formed between the dielectric substrate 2 and the metal ground 3. Both the metal ground 3 and the dielectric substrate 2 may be integrally formed with the metal sheet 1 through injection molding. Alternatively, the metal sheet 1 and the dielectric substrate 2 may be integrally formed through injection molding, and then the dielectric substrate 2 is fastened to the metal ground 3 through welding or the like. In this structure, when the mechanical part 4 is made of a metal material, the mechanical part 4 may be connected to the metal sheet 1 to serve as a ground point for grounding of the metal sheet 1. For a structure of the resonant cavity antenna 10 after combination, refer to the structure shown in Embodiment 1, which is not shown again herein.

After a first connection port 101 of the resonant cavity antenna 10 communicates with an audio chamber of an audio module 30, the internal cavity Q1 can be used as a portion of an acoustic cavity to expand a volume of the acoustic cavity. It should be understood that, a communication structure between the resonant cavity antenna 10 and the audio module 30 is similar to that in Embodiment 1, and a difference lies in a specific implementation of the internal cavity Q1. Therefore, a fitting structure between the resonant cavity antenna 10 and the audio module 30 is not exemplified herein. Certainly, when the resonant cavity antenna 10 is used in an electronic device having a metal housing 20, a metal casing 201 of the metal housing 20 may replace the metal ground 3 in the resonant cavity antenna 10. The fitting manner is also further described in Embodiment 1. Details are not described herein again.

### Embodiment 7

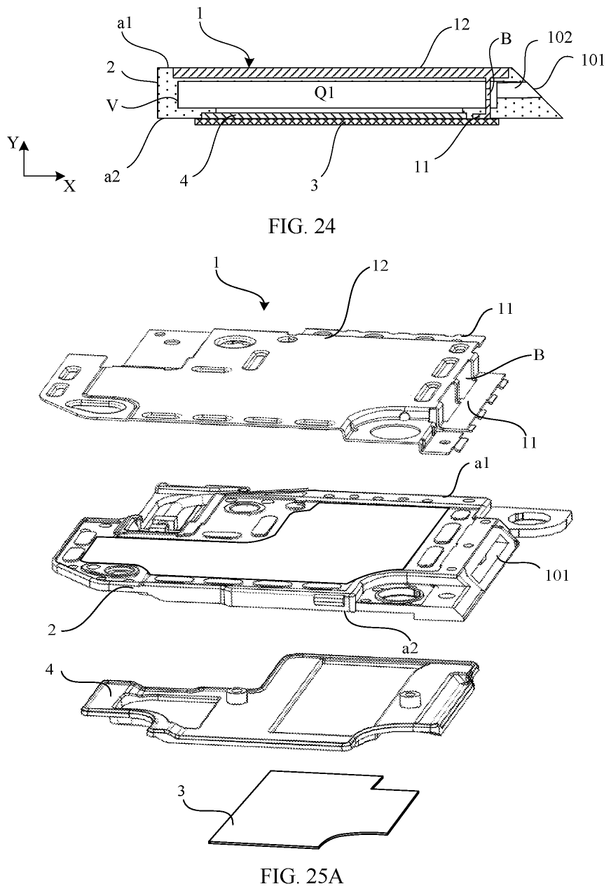

FIG. 24 is a simplified diagram of a cross-sectional structure of a resonant cavity antenna 10. The resonant cavity antenna 10 includes a metal sheet 1, a dielectric substrate 2, a metal ground 3, and a mechanical part 4. Compared with the structure of the resonant cavity antenna 10 shown in Embodiment 6, a difference lies in that in the resonant cavity antenna 10 provided in this embodiment of this application, the dielectric substrate 2 and the mechanical part 4 work with each other to form the internal cavity Q1. In a Z direction, the dielectric substrate 2 includes a first surface a1 and a second surface a2 that are opposite to each other. The metal sheet 1 may be made of a steel sheet, and the metal sheet 1 is fastened to the dielectric substrate 2 in an integrated injection molding manner. A top plate 12 of the metal sheet 1 is located on the first surface a1 of the dielectric substrate 2. The dielectric substrate 2 has an open slot C, and an opening of the open slot C is located on the second surface a2. The mechanical part 4 is fastened to a side of the second surface a2 of the dielectric substrate 2, and seals the opening of the open slot C, so that the dielectric substrate 2 and the mechanical part 4 form the internal cavity Q1. The metal ground 3 is disposed on a side that is of the mechanical part 4 and that is away from the second surface a2 of the dielectric substrate 2. The pin 11 of the metal sheet 1 extends toward a side of the second surface a2 of the dielectric substrate 2, and is conductively connected to the metal ground 3. The mechanical part 4 avoids interfering with the pin 11.

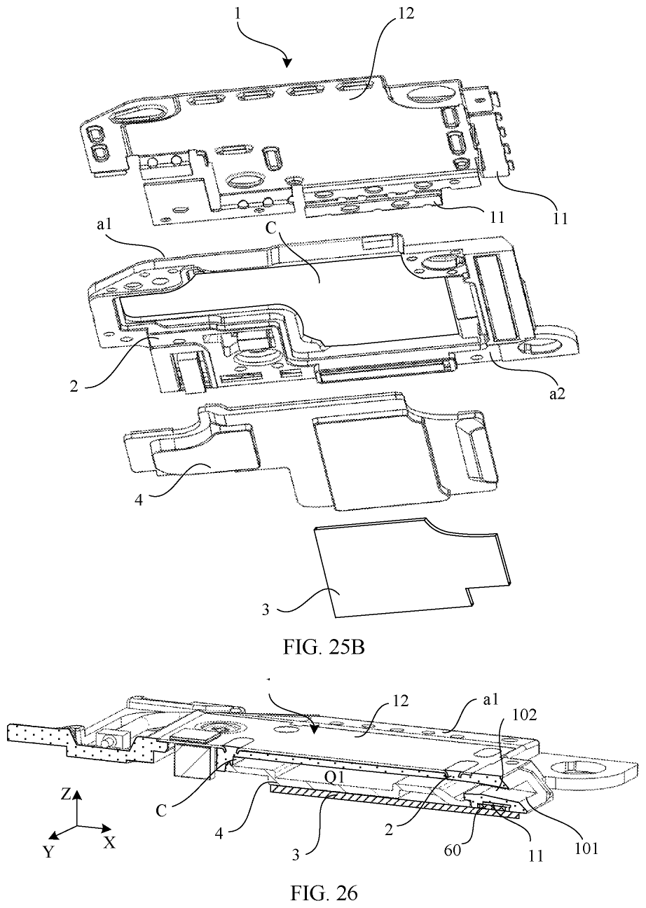

FIG. 25A and FIG. 25B are exploded views of a possible implementation of the resonant cavity antenna 10 shown in FIG. 24. FIG. 26 is a diagram of a partial cross-sectional structure of the resonant cavity antenna 10. The first surface a1 of the dielectric substrate 2 is closed. The opening of the open slot C of the dielectric substrate 2 is located on the second surface a2. The mechanical part 4 is fastened to the dielectric substrate 2 and seals the opening of the open slot C. The closed internal cavity Q1 can be formed between the dielectric substrate 2 and the mechanical part 4. The pin 11 of the metal sheet 1 may be conductively connected to the metal ground 3 through conductive foam 60. In this structure, when the mechanical part 4 is made of a metal material, the mechanical part 4 may be connected to the metal sheet 1 to serve as a ground point of the metal sheet 1 for connecting to the metal ground 3.

After a first connection port 101 of the resonant cavity antenna 10 communicates with an audio chamber of an audio module 30, the internal cavity Q1 can be used as a portion of an acoustic cavity to expand a volume of the acoustic cavity. It should be understood that, a communication structure between the resonant cavity antenna 10 and the audio module 30 is similar to that in Embodiment 1, and a difference lies in a specific implementation of the internal cavity Q1. Therefore, a fitting structure between the resonant cavity antenna 10 and the audio module 30 is not exemplified herein. Certainly, when the resonant cavity antenna 10 is used in an electronic device having a metal housing 20, a metal casing 201 of the metal housing 20 may replace the metal ground 3 in the resonant cavity antenna 10. The fitting manner is also further described in Embodiment 1. Details are not described herein again.

### Embodiment 8

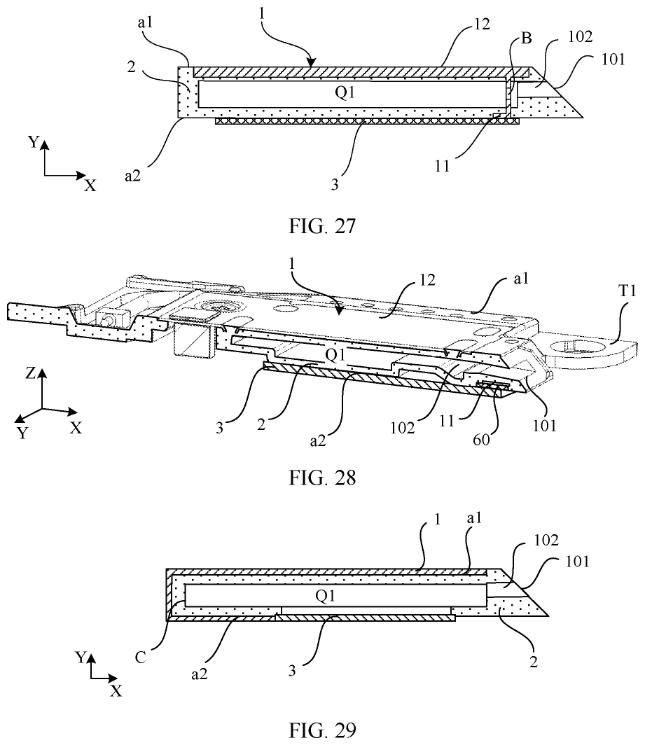

FIG. 27 is a simplified diagram of a cross-sectional structure of a resonant cavity antenna 10. The resonant cavity antenna 10 includes a metal sheet 1, a dielectric substrate 2, and a metal ground 3. Compared with the structure of the resonant cavity antenna 10 shown in Embodiment 1, a difference lies in that in the resonant cavity antenna 10 provided in this embodiment of this application, a structure of the dielectric substrate 2 forms the internal cavity Q1. In a Z direction, the dielectric substrate 2 includes a first surface a1 and a second surface a2 that are opposite to each other. A top plate 12 of the metal sheet 1 is located on the first surface a1 of the dielectric substrate 2, and a pin 11 of the metal sheet 1 passes through the dielectric substrate 2 and is at least partially exposed from the second surface a2 of the dielectric substrate 2. The metal ground 3 is located on a side of the second surface a2 of the dielectric substrate 2, and the metal ground 3 is conductively connected to the pin 11.

FIG. 28 is a diagram of a partial cross-sectional structure of a possible implementation of the resonant cavity antenna 10 shown in FIG. 27. The metal sheet 1 may be made of a steel sheet, and the metal sheet 1 is fastened to the dielectric substrate 2 in an integrated injection molding manner, so that the top plate 12 is located on the first surface a1 of the dielectric substrate 2, and the pin 11 passes through the dielectric substrate 2 to be exposed from the second surface a2 of the dielectric substrate. The metal ground 3 may be fastened to the second surface a2 of the dielectric substrate 2 in a welding manner, and the metal ground 3 is conductively connected to the pin 11 through conductive foam 60 for example. The dielectric substrate 2 is of a cavity structure. An inner wall of the cavity structure of the dielectric substrate 2 may form a closed internal cavity Q1. The first surface a1 and the second surface a2 of the dielectric substrate 2 are both closed. A communication channel 102 and a first connection port 101 are further formed on the dielectric substrate 2, and the first connection port 101 communicates with the internal cavity Q1 through the communication channel 102.

It should be understood that the dielectric substrate 2 in the resonant cavity antenna 10 may be formed by the mechanical part 4 and the dielectric substrate 2 in Embodiment 7 through injection molding. Alternatively, the dielectric substrate 2 in the resonant cavity antenna 10 may be formed by buckling the two grooves of the dielectric substrate 2 in Embodiment 2 opposite to each other.

After the first connection port 101 of the resonant cavity antenna 10 communicates with an audio chamber of an audio module 30, the internal cavity Q1 can be used as a portion of an acoustic cavity to expand a volume of the acoustic cavity. It should be understood that, a communication structure between the resonant cavity antenna 10 and the audio module 30 is similar to that in Embodiment 1, and a difference lies in a specific implementation of the internal cavity Q1. Therefore, a fitting structure between the resonant cavity antenna 10 and the audio module 30 is not exemplified herein. Certainly, when the resonant cavity antenna 10 is used in an electronic device having a metal housing 20, a metal casing 201 of the metal housing 20 may replace the metal ground 3 in the resonant cavity antenna 10. The fitting manner is also further described in Embodiment 1. Details are not described herein again.

### Embodiment 9

FIG. 29 is a simplified diagram of a cross-sectional structure of a resonant cavity antenna 10. A difference from Embodiment 7 lies in that in the resonant cavity antenna 10 provided in this embodiment of this application, a metal sheet 1 is made of a flexible printed circuit board. The metal sheet 1 wraps a surface of a dielectric substrate 2. At least a portion of the metal sheet 1 is located on a first surface a1 of the dielectric substrate 2, and at least a portion of the metal sheet 1 is located on a second surface a2 of the dielectric substrate 2. The dielectric substrate 2 has an open slot C with an opening located on the second surface a2. A metal ground 3 seals the opening of the open slot C, so that the dielectric substrate 2 and the metal ground 3 work with each other to form an internal cavity Q1.

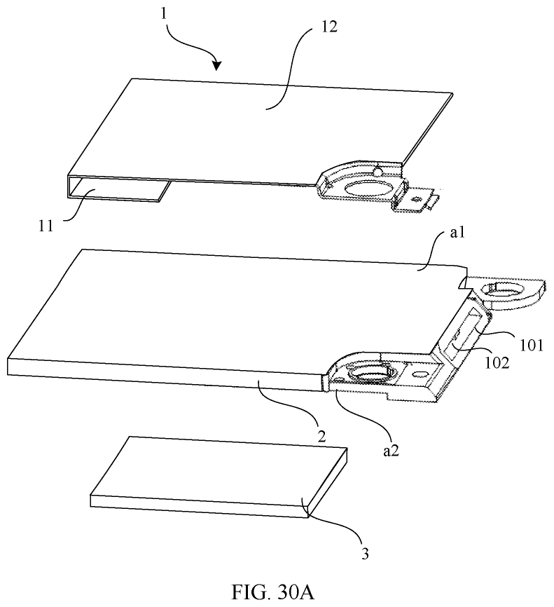

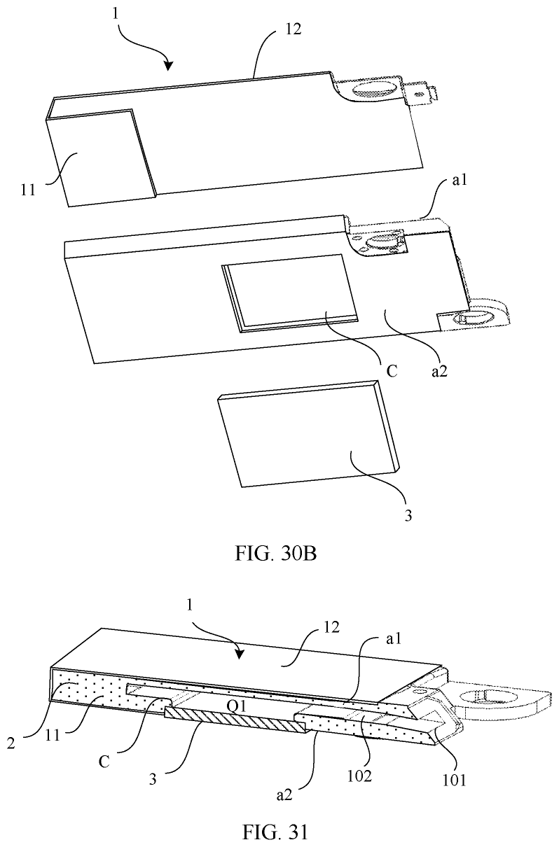

FIG. 30A and FIG. 30B are exploded views of a possible implementation of the resonant cavity antenna 10 shown in FIG. 29. FIG. 31 is a diagram of a partial cross-sectional structure of the resonant cavity antenna 10. The metal sheet 1 is of a bent structure, and includes a top plate 12 and a pin 11 with an integrated structure. The metal sheet 1 bends and wraps an outer surface of the dielectric substrate 2. The top plate 12 is located on the top plate 12 of the first surface a1 of the dielectric substrate 2, the pin 11 is located on the second surface a2 of the dielectric substrate 2, and space between the top plate 12 and the pin 11 is used to accommodate the dielectric substrate 2. The metal ground 3 is located on a side of the second surface a2 of the dielectric substrate 2, and the pin 11 is configured to connect to the metal ground 3 for grounding.

It should be understood that the metal ground 3 and the pin 11 in this embodiment may be of an integrated structure. In other words, the metal sheet 1 may be large enough to cover the opening of the open slot C of the dielectric substrate 2 after the metal sheet 1 is bent. A partial structure that is of the metal sheet 1 and that is located on the second surface a2 of the dielectric substrate 2 may be considered as the metal ground 3.

For a structure of the dielectric substrate 2 and formation of the internal cavity Q1, refer to an implementation in another embodiment. For example, when the first surface a1 of the dielectric substrate 2 in this embodiment is opened and sealed by using the metal sheet 1, the dielectric substrate 2 may be considered as the dielectric substrate shown in Embodiment 3. When the first surface a1 of the dielectric substrate 2 in this embodiment is opened and sealed by using the metal sheet 1, and the second surface a2 is opened and sealed by using the metal ground 3, the dielectric substrate 2 may be considered as the dielectric substrate 2 shown in Embodiment 2. When the first surface a1 of the dielectric substrate 2 in this embodiment is opened and sealed by using the metal sheet 1, and the second surface a2 is opened and sealed by using a mechanical part 4, the dielectric substrate 2 may be considered as the dielectric substrate 2 in Embodiment 1. When the dielectric substrate 2 in this embodiment is formed by connecting the first substrate 21 and the second substrate 22, the dielectric substrate 2 may be considered as a structural deformation of the dielectric substrate 2 in Embodiment 5.

After a first connection port 101 of the resonant cavity antenna 10 communicates with an audio chamber of an audio module 30, the internal cavity Q1 can be used as a portion of an acoustic cavity to expand a volume of the acoustic cavity. It should be understood that, a communication structure between the resonant cavity antenna 10 and the audio module 30 is similar to that in Embodiment 1, and a difference lies in a specific implementation of the internal cavity Q1 and an implementation of the metal sheet 1. Therefore, a fitting structure between the resonant cavity antenna 10 and the audio module 30 is not exemplified herein. Certainly, when the resonant cavity antenna 10 is used in an electronic device having a metal housing 20, a metal casing 201 of the metal housing 20 may replace the metal ground 3 in the resonant cavity antenna 10. The fitting manner is also further described in Embodiment 1. Details are not described herein again.

It should be understood that the foregoing embodiments are examples of several possible structures of the resonant cavity antenna 10 provided in this application, which are not limited to the foregoing several embodiments. The structures in the foregoing listed different embodiments may be superimposed, replaced, or omitted according to usage scenes, provided that the closed internal cavity Q1 can be formed in the resonant cavity antenna 10. The internal cavity Q1 can communicate with the audio chamber of the audio module 30 to expand a volume of the acoustic cavity, that is, the technical solution to be protected in embodiments of this application. For example, the metal ground 3 in Embodiment 4 may alternatively be used as the mechanical part 4 made of a metal material in Embodiment 3. Both the metal ground 3 and the mechanical part 4 may be considered as a structure made of a metal material, without being limited by the specific names. Alternatively, for example, the manner of forming the dielectric substrate 2 by using the first substrate 21 and the second substrate 22 in Embodiment 5 may alternatively be used in a manner of forming the dielectric substrate 2 of the resonant cavity antenna 10 in another embodiment. For the implementation in which the metal sheet 1 is a flexible printed circuit board, schemes such as various structural deformations of the dielectric substrate 2, formation of the internal cavity Q1 between the dielectric substrate 2 and the metal sheet 1, formation of the internal cavity Q1 between the dielectric substrate 2 and the mechanical part 4, and formation of the internal cavity Q1 between the dielectric substrate 2 and the metal ground 3, may all be implemented on this basis. Details are not described herein again.

In conclusion, according to the resonant cavity antenna 10 provided in embodiments of this application, the internal cavity Q1 is formed by using a structure of the resonant cavity antenna 10. The internal cavity Q1 may be configured to communicate with the audio chamber Q2 of the audio module 30, to expand a volume of the acoustic cavity of the audio module 30 and improve sound quality of the audio module 30. The internal cavity Q1 implements volume expansion of the acoustic cavity of the audio module 30 without increasing space occupied by the resonant cavity antenna 10. This can resolve a problem that space of the acoustic cavity of the audio module 30 is compressed due to the large space occupied by the resonant cavity antenna 10. The electronic device having the resonant cavity antenna 10 offers better experience in terms of audio play.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A resonant cavity antenna, comprising:
a dielectric substrate;
a metal ground fastened to the dielectric substrate;
a metal sheet fastened to the dielectric substrate, spaced apart from the metal ground, and comprising a ground point conductively coupled to the metal ground, wherein the metal sheet and the metal ground form a resonant cavity body; and
an internal cavity configured to communicate with an audio chamber of an audio device and at least partially located between the metal sheet and the metal ground.

2. The resonant cavity antenna of claim 1, wherein the dielectric substrate comprises:
a first surface fastened to the metal sheet; and
a second surface opposite the first surface and fastened to the metal ground, and
wherein the ground point is exposed from the second surface.

3. The resonant cavity antenna of claim 2, wherein the dielectric substrate comprises a hollow extending between the first surface and the second surface and comprising:
a first opening at the first surface, wherein the metal sheet seals the first opening; and
a second opening at the second surface, and
wherein either the metal ground seals the second opening such that the metal sheet, the hollow, and the metal ground form the internal cavity, or the resonant cavity antenna further comprises a mechanical part configured to seal the second opening such that the metal sheet, the hollow, and the mechanical part form the internal cavity.

4. The resonant cavity antenna of claim 3, wherein the mechanical part comprises a metal material and couples the ground point to the metal ground.

5. The resonant cavity antenna of claim 2, wherein the dielectric substrate comprises an open slot with an opening located on the first surface, and wherein the metal sheet seals the opening such that the metal sheet and the open slot form the internal cavity.

6. The resonant cavity antenna of claim 2, wherein the dielectric substrate comprises an open slot with an opening located on the first surface, and wherein the metal ground seals the opening such that the metal ground and the open slot form the internal cavity, or the resonant cavity antenna further comprises a mechanical part seals the opening such that the mechanical part and the open slot form the internal cavity.

7. The resonant cavity antenna of claim 2, wherein the dielectric substrate comprises a cavity structure, and wherein the cavity structure comprises an inner wall that forms the internal cavity.

8. The resonant cavity antenna of claim 2, wherein the dielectric substrate comprises:
a first substrate fastened to the metal sheet and comprising a third surface; and
a second substrate fastened to the metal ground, coupled to the first substrate, and comprising a fourth surface facing away from the first substrate, and
wherein the third surface faces away from the second substrate.

9. The resonant cavity antenna of claim 1, wherein the dielectric substrate comprises:
a first connection port configured to communicate with the audio chamber; and
a communication channel coupled between the internal cavity and the first connection port.

10. The resonant cavity antenna of claim 1, wherein the metal sheet comprises:
a top plate; and
a pin coupled to the top plate and configured to:
couple to the metal ground as the ground point; and
be in surface contact with the metal ground.

11. The resonant cavity antenna of claim 1, wherein the metal sheet is a steel sheet or a flexible printed circuit board.

12. The resonant cavity antenna of claim 1, further comprising a conducive foam, wherein the ground point is coupled to the metal ground through the conductive foam.

13. An electronic device, comprising:
a resonant cavity antenna comprising:
a dielectric substrate;
a metal ground fastened to the dielectric substrate;
a metal sheet fastened to the dielectric substrate, comprising a ground point conductively coupled to the metal ground, and spaced apart from the metal ground, wherein the metal sheet and the metal ground form a resonant cavity body; and
an internal cavity disposed at least partially within the resonant cavity body; and
an audio device comprising an audio chamber configured to communicate with the internal cavity.

14. The electronic device of claim 13, further comprising a metal housing, wherein a portion of the metal housing is the metal ground.

15. The electronic device of claim 14, wherein the dielectric substrate comprises a surface fastened to the metal ground and comprising:
a first side edge; and
a second side edge opposite to the first side edge and comprising the ground point, and
wherein the metal housing is fastened to the dielectric substrate and comprises a metal middle frame that is perpendicular to the metal housing and that is positioned adjacent the first side edge and opposite to the second side edge.

16. The electronic device of claim 15, further comprising a gap between the resonant cavity antenna and the metal middle frame, wherein the resonant cavity antenna is configured to transmit or receive an electromagnetic wave through the gap.

17. The electronic device of claim 13, wherein the resonant cavity antenna further comprises a first connection port configured to communicate with the internal cavity, and wherein the audio device comprises a second connection port that is configured to communicate with the audio chamber and that is in sealed communication with the first connection port.

18. The electronic device of claim 17, wherein the dielectric substrate comprises a communication channel between the first connection port and the second connection port, wherein the resonant cavity antenna further comprises a sealing ring between the first connection port and the second connection port, and wherein the sealing ring surrounds the communication channel.

19. The electronic device of claim 18, wherein the sealing ring comprises a sealing foam or a sealing rubber sleeve.

20. The electronic device of claim 18, wherein the audio device and the resonant cavity antenna are disposed at a same layer of the electronic device, wherein the first connection port comprises a first end face configured to couple to the second connection port, wherein the second connection port comprises a second end face configured to couple to the first connection port, and wherein the first end face and the second end face are inclined and parallel to each other in an arrangement direction of the audio device and the resonant cavity antenna.
